(19) United States
(12) Patent Application Publication
(10) Pub. No.: US 2003/0076360 A1
(43) Pub. Date: Apr. 24, 2003

(54) Project management system

(76) Inventor: Jason Barrow, Stamford, CT (US)

Correspondence Address: BUCKLEY, MASCHOFF, TALWALKAR, & ALLISON, 5 ELM STREET, NEW CANAAN, CT, 06840, US

(21) Appl. No.: 09/982,429

(22) Filed: Oct. 18, 2001

(51) Int. Cl. G09G 5/00

(52) U.S. Cl. 345/771

(57) ABSTRACT

A medium for managing a project includes a first area having representations of each of a plurality of steps, a second area having representations of a plurality of substeps corresponding to one of the plurality of steps, and a third area, displayed in response to a selection of one of the plurality of substeps. The third area includes a representation of the selected substep, representations of at least one and less than all of substeps preceding the selected substep, representations of at least one and less than all of the substeps following the selected substep, and instructions for performing the selected substep.

### BACKGROUND OF THE INVENTION

1. Field of the Invention

The present invention relates to systems for managing projects. More specifically, the present invention concerns a system for facilitating the monitoring and execution of steps for completing a project.

2. Discussion of the Prior Art

Many types of systems for managing projects are currently available. Some of these systems allow a project manager, coordinator or other entity to define tasks required to complete a project, as well as timeframes and prerequisites corresponding to each task. Using this information, some of these systems produce an optimal timeline for the project that illustrates an optimized order in which the tasks should be performed. Moreover, some systems allow a manager to track actual project progress and to adjust or revise the optimal timeline as a project progresses.

Current systems fail to provide an efficient system for viewing and performing steps of a particular project. In this regard, current systems are only marginally helpful in instructing a manager as to how particular processes should be performed. Current systems also do not satisfactorily demonstrate relationships between project steps in a manner that is easily grasped by a manager.

In view of the foregoing, what is needed is a system that efficiently provides instructions for accomplishing a project as well as a clear presentation of relationships between steps of the project. Such a system should also allow for intuitive navigation among the steps and the instructions for performing each step.

### BRIEF SUMMARY OF THE INVENTION

In order to address the foregoing, the present invention concerns a system, a user interface, a method, an apparatus, a computer-readable medium storing processor-executable process steps, and means to manage a process in which a first area comprising representations of each of a plurality of steps is displayed, a second area comprising representations of a plurality of substeps corresponding to one of the plurality of steps is displayed, a selection of one of the plurality of substeps is received, and a third area is displayed in response to the selection. According to some embodiments, the third area includes a representation of the selected one of the plurality of substeps, representations of at least one and less than all of substeps preceding the selected substep, representations of at least one and less than all of the substeps following the selected substep, and instructions for performing the selected substep. By virtue of the foregoing steps, a manager may efficiently view, comprehend, and execute steps of a project.

In another aspect, the present invention concerns a user interface that includes representations of each of a first plurality of steps and representations of each of a plurality of substeps corresponding to one of the first plurality of steps. According to this aspect, one of the plurality of substeps is selectable to cause display of at least a representation of the selected substep, representations of at least one and less than all of substeps preceding the selected substep, representations of at least one and less than all of the substeps following the selected substep, and instructions for performing the selected substep.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a view of a user interface displaying level one process steps according to embodiments of the invention.

FIG. 2 is a view of a user interface displaying level one and level two process steps according to embodiments of the invention.

FIG. 3 is a view of a user interface displaying level two process steps and instructions according to embodiments of the invention.

FIG. 4 is a diagram of a system architecture according to embodiments of the invention.

FIG. 5 is a block diagram illustrating an internal architecture of a project management server according to embodiments of the present invention.

FIG. 6 is a block diagram illustrating an internal architecture of a manager device according to embodiments of the present invention.

FIG. 7 is a tabular representation of a portion of a project information database according to embodiments of the present invention.

FIG. 8 illustrates a flow diagram of process steps to provide project management according to embodiments of the invention.

FIG. 9 is a view of graphics displayed to a manager according to embodiments of the invention.

FIG. 10 is a view of graphics displayed to a manager according to embodiments of the invention.

FIGS. 11 through 13 comprise views of user interfaces illustrating level one and level two process steps according to embodiments of the invention.

FIGS. 14 through 61 comprise views of user interfaces illustrating level two process steps and instructions according to embodiments of the invention.

### DETAILED DESCRIPTION OF THE INVENTION

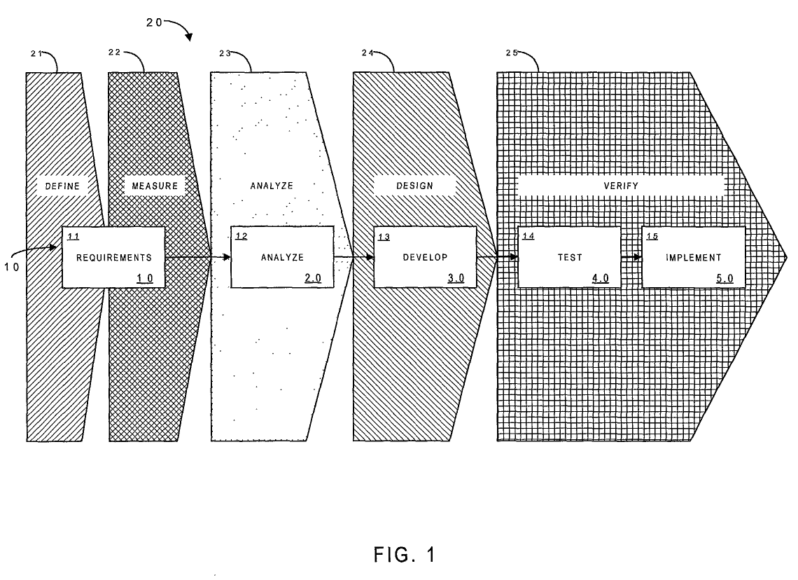

FIG. 1 is a view of a user interface displaying representations of level one process steps 10 according to embodiments of the present invention. The FIG. 1 user interface may be initially presented to a project manager, and is intended to provide a view of major processes involved in a project.

As shown, representations of process steps 10 are superimposed on representations of individual elements of project framework 20. Project framework 20 may comprise general guidelines for completing projects that have been adopted by an entity employing the manager. In this regard, superimposition of process steps 10 over such a framework allows a manager or other employee who is already familiar with the framework to better understand each of process steps 10. Adoption of such a framework allows the entity to establish an approach for developing needed systems. A standard approach facilitates communication between and improves the efficiency of employees in developing the systems. The particular approach reflected in project framework 20 is an element of the renowned six-sigma business practices implemented by General Electric Corporation.

As shown in FIG. 1, respective ones of process steps 10 are intended to implement those elements of project framework 20 on which representations of the steps are superimposed. For example, Requirements step 1.0 is intended to implement Define element 21 and Measure element 22, while Analyze step 2.0 is intended to implement Analyze element 23.

The user interface of FIG. 1 may be displayed to a manager on any type of display system and may be produced by any appropriate software and/or hardware. In some embodiments, the user interface is a portion of a document created using a word processing application such as Microsoft Word®, and the representations of each of process steps 10 are objects created using functions provided by the application. As such, each representation may include a hyperlink referencing other portions of the document and may thereby be selected by a manager to cause display of the other portions. In some embodiments, the user interface is a World Wide Web (“Web”) page requested and received by the manager. The representations of process steps 10 may therefore also comprise a hyperlink to other Web pages. Of course, any other known system for providing navigation among displayed user interfaces may be used to implement embodiments of the invention.

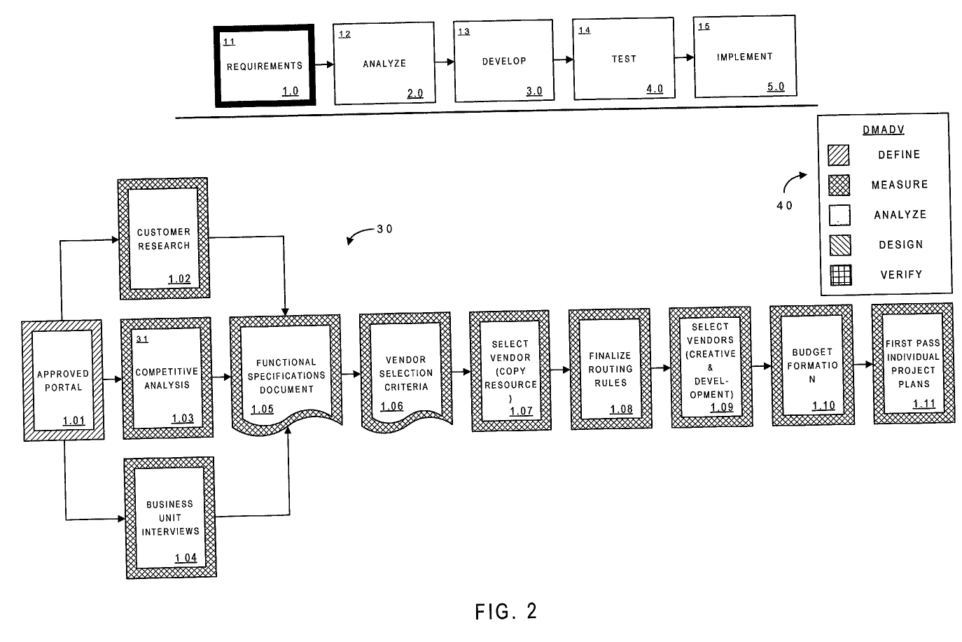

FIG. 2 illustrates a user interface that may be displayed in a case that the manager selects representation 11 of FIG. 1. It should be noted that selection of a representation is deemed to include selection of a step represented by the representation, and that selection of a step is deemed to include selection of a representation of the step. The user interface of FIG. 2 is displayed because representation step 11 comprises a hyperlink to the user interface of FIG. 2. This user interface may simply exist on a page of a word processing document that also includes the user interface of FIG. 1, or may comprise a Web page having a unique Web address.

In FIG. 2, representations of process steps 10 are shown in a first area and representations of level two process steps 30 are shown in a second area. In some embodiments, however, the first area and the second area are not displayed simultaneously. Representation 11 is highlighted to indicate that process steps 30 are substeps corresponding to step 1.0, thereby conveniently indicating a context of process steps 30 within process steps 10. Also shown in FIG. 2 is project framework legend 40. Legend 40 associates each element of project framework 20 with a particular designation, such as a pattern. The designations are used to identify relationships between steps of level two process steps 30 and elements of project framework 20. For example, a manager may identify that a step of process steps 30 is intended to implement an element of project framework 20 if a displayed representation of the step reflects a designation that is associated with the element in legend 40.

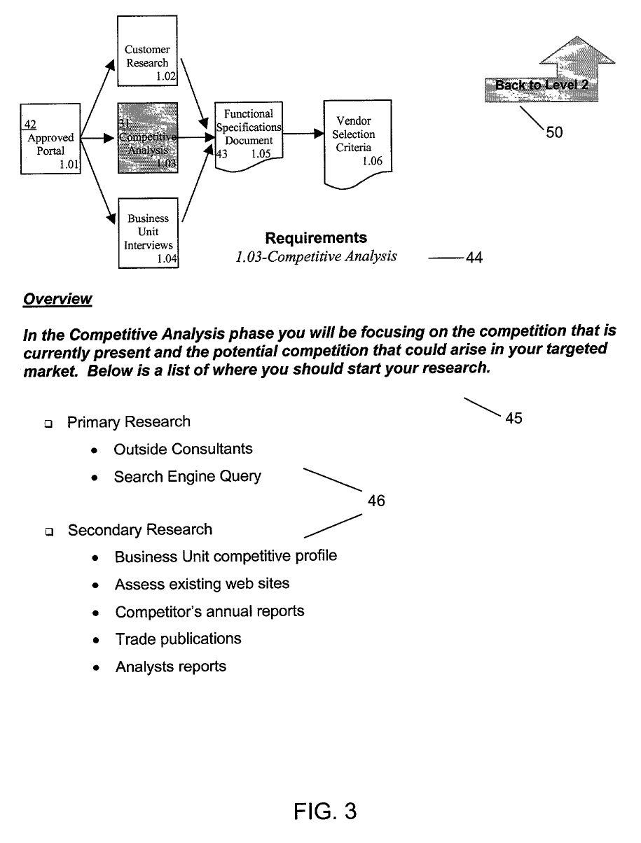

Each representation of process steps 30 may also comprise a word processing object and/or a hyperlink as described above. Each representation may therefore be selectable to cause display of a related user interface. For example, FIG. 3 illustrates a third area of a user interface that may be displayed in response to selection of representation 31 of step 1.03. The area illustrated in FIG. 3 may be displayed simultaneously with or independently from the user interface of FIG. 1, the first area of FIG. 2, and/or the second area of FIG. 2.

Specifically, FIG. 3 shows representation 31 along with representations of several other of process steps 30 that precede or follow step 1.03. Also shown are title 44, overview 45 and instructions 46 corresponding to step 1.03. Instructions 46 may comprise notes, reminders, general instructions, detailed instructions, or any other information useful for performing step 1.03. It should be noted that the displayed representations represent less than all of the steps of process steps 30. By displaying representations of less than all of process steps 30 along with representation 31, the interface of FIG. 3 provides a convenient reference to the context of step 1.03 that may be helpful in interpreting overview 45 and/or instructions 46. Each of the displayed representations may also be selected to cause display of a user interface that is similar to the FIG. 3 interface but that also includes information relating to a step represented by the representation.

FIG. 3 also shows graphic 50. Graphic 50 may be selected to cause display of level two process steps corresponding to the subject process step. In a case that the subject process step is step 1.03, the corresponding level two process steps are process steps 30. Accordingly, in one embodiment, selection of graphic 50 causes re-display of the user interface of FIG. 2. This described functionality of graphic 50 may be provided by any of the above-described techniques.

As should be understood, the features described with respect to FIGS. 1 to 3 efficiently provide instructions for accomplishing a project, a clear presentation of relationships between steps of the project, and instructions for performing each step. In one contemplated use of these features, details of which are provided below, a project planner inputs details of steps required to complete a project. According to the present description, the project comprises development of a Web site. The details include a relative order of the steps, substeps corresponding to each step, a relative order of the substeps, and instructions for completing each substep.

Once the details have been input, a project manager executes a computer program that generates the interfaces of FIGS. 1 to 3 based on the details. Particularly, the project manager may execute a project management program to assist in planning or otherwise managing the development of a Web site. The program identifies project details associated with the particular project and presents the FIG. 1 interface to the project manager. Of course, the identified project details may be received from the project manager instead of from the project planner.

The program generates and presents various versions of the FIG. 1, 2, and 3 interfaces in response to commands received from the project manager. In this regard, the project manager navigates between the interfaces in order to view interrelations of project steps and substeps and also to determine how to execute the substeps. Such navigation is facilitated through the selectable objects, links and icons presented by the interfaces.

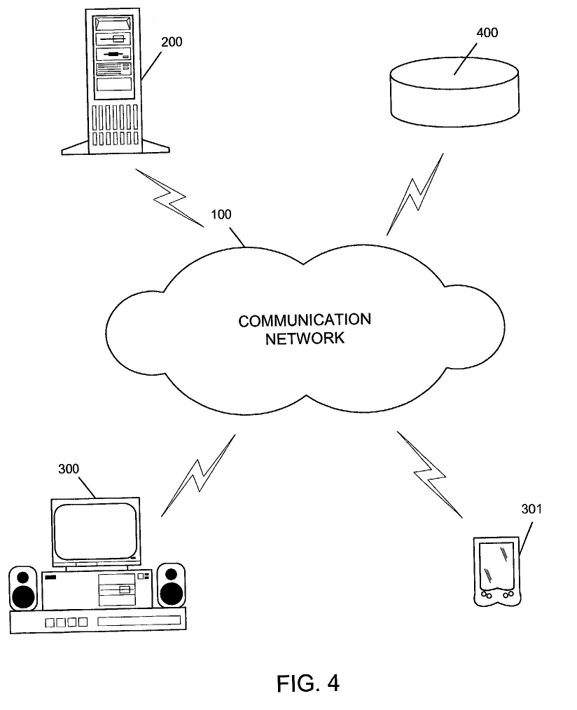

As an illustration of one possible system for implementing the foregoing, FIG. 4 shows communication network 100 in communication with project management server 200, manager devices 300 and 301, and data repository 400. Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Moreover, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

Project management server 200 may comprise a network server or other device capable of performing the functions described herein. Project management server 200 may provide project management services for a single entity, such as an entity employing managers operating manager devices 300 and 301, or for more than one entity. Therefore, project management server 200 may be an element of an intranet or a virtual private network including devices 300 and 301.

According to some embodiments, project management server 200 operates to display a first area comprising representations of each of a plurality of steps, to display a second area comprising representations of a plurality of substeps corresponding to one of the plurality of steps, to receive a selection of one of the plurality of substeps, and a step to display a third area in response to the selection. The third area comprises a representation of the selected one of the plurality of substeps, representations of at least one and less than all of substeps preceding the selected substep, representations of at least one and less than all of the substeps following the selected substep, and instructions for performing the selected substep. Project management server 200 may provide other functions desired by the entities for which server 200 provides project management services. These functions may include inventory, purchasing, payroll, accounting, and reporting functions.

Manager devices 300 and 301 comprise a workstation and a Personal Digital Assistant (PDA), respectively, for providing functionality to one or more project managers. In this regard, manager devices 300 and 301 may be used by a manager to input level one process steps, level two process steps, and instructions associated with steps, to view user interfaces, and to select representations of steps so as to cause display of related interfaces. Manager devices 300 and 301 may also be used to provide other functions to a manager, including e-mail services, word processing, calendaring, presentation development, budgeting, and the like.

Data repository 400 may store data used to generate user interfaces according to embodiments of the invention. Such data may include word processing documents including user interfaces, and data specifying project information such as process steps, an order of the steps, and instructions for performing each process step. Of course, this data may also be stored in server 200 or in one of manager devices 300 and 301.

In other embodiments, the devices of FIG. 4 are connected differently than as shown. For example, some or all of the devices may be connected directly to one another. Of course, embodiments of the invention may include devices that are different from those shown. It should also be noted that although the devices are shown in communication with each other, the devices need not be constantly exchanging data. Rather, communication may be established when necessary and severed at other times or always available but rarely used to transmit data. Moreover, although the illustrated communication links appear dedicated, it should be noted that each of the links may be shared by other devices.

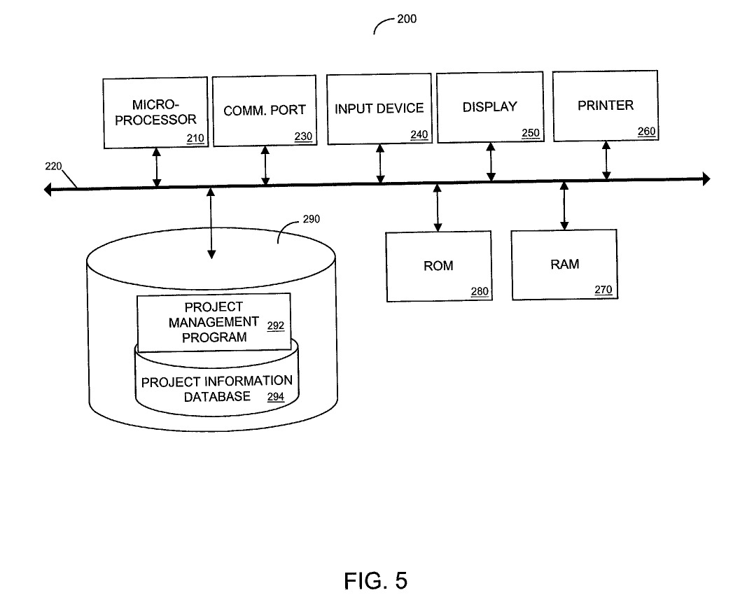

FIG. 5 is a block diagram of an internal architecture of project management server 200 according to embodiments of the invention. As illustrated, server 200 includes microprocessor 210 in communication with communication bus 220. Microprocessor 210 may be a Pentium, RISC-based, or other type of processor and is used to execute processor-executable process steps so as to control the elements of server 200 to provide desired functionality.

Also in communication with communication bus 220 is communication port 230. Communication port 230 is used to transmit data to and to receive data from devices external to project management server 200. Communication port 230 is therefore preferably configured with hardware suitable to physically interface with desired external devices and/or network connections. For example, communication port 230 may comprise an Ethernet connection to a local area network through which project management server 200 may receive and transmit information over the Web.

Input device 240, display 250 and printer 260 are also in communication with communication bus 220. Any known input device may be used as input device 240, including a keyboard, mouse, touch pad, voice-recognition system, or any combination of these devices. Input device 240 may be used by an operator of project management server 200 to input project information, commands to transmit a user interface to a manager, and other information. Of course, such information may also be input to project management server 200 via communication port 230.

Information may be presented to an operator user via display 250, which may be an integral or separate CRT display, flat-panel display or the like, in response to commands issued by microprocessor 210. Such information may include user interfaces according to embodiments of the invention or other text and graphics. Printer 260 may also present text and graphics to a user, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores, among other data, processor-executable process steps of project management program 202. Microprocessor 210 executes the process steps of project management program 202 in order to control project management server 200 to manage a project. More specifically, the process steps of project management program 202 may be executed by microprocessor 210 to display a first area comprising representations of each of a plurality of steps, to display a second area comprising representations of a plurality of substeps corresponding to one of the plurality of steps, to receive a selection of one of the plurality of substeps, and a step to display a third area in response to the selection, wherein the third area comprises a representation of the selected one of the plurality of substeps, representations of at least one and less than all of substeps preceding the selected substep, representations of at least one and less than all of the substeps following the selected substep, and instructions for performing the selected substep.

The process steps of project management program 292 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Process management program 292 may also comprise processor-executable process steps of a Web server. The process steps may be executed by microprocessor 210 to transmit data to and to receive data from Web clients, such as Web browsers, over the Web. As described above, the data may include selections of representations, and Web pages presenting user interfaces.

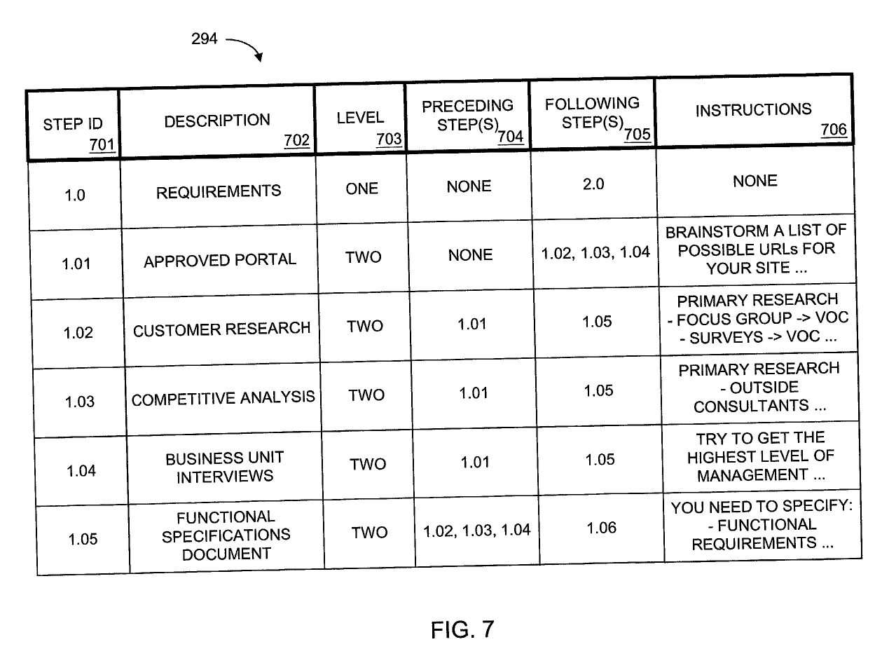

Project information database 294 is also stored in data storage device 290. Project information database 294 includes information related to process steps of one or more projects. Such information may be used to generate user interfaces such as shown in FIGS. 1 through 3. One example of project information database 294 is described below with respect to FIG. 7.

Also stored in data storage device 290 may also be other unshown elements that may be necessary for operation of project management server 200, such as other applications, other data files, an operating system, a database management system and “device drivers” for allowing microprocessor 210 to interface with devices in communication with communication port 230. These elements are known to those skilled in the art, and are therefore not described in detail herein.

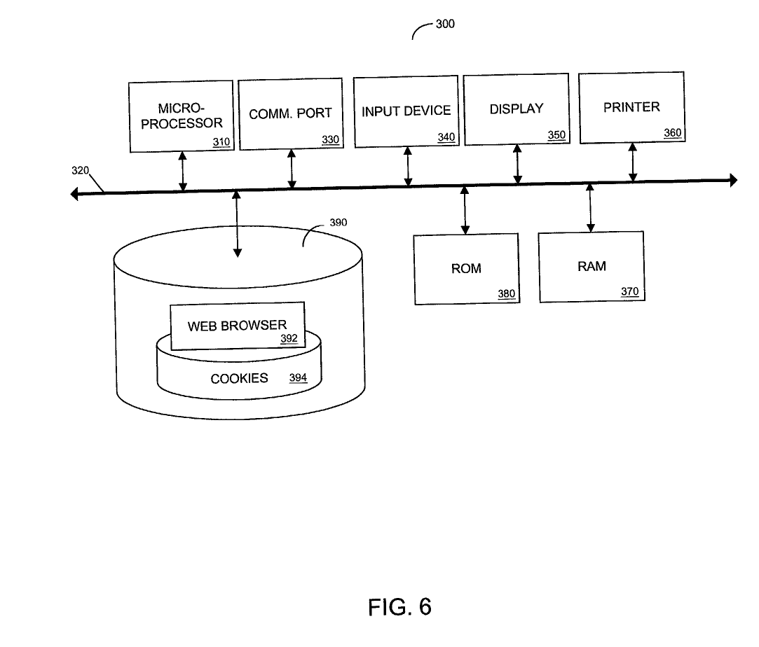

FIG. 6 illustrates several components of manager device 300 according to one embodiment of the invention. The components may comprise any of the specific examples set forth above with respect to identically-named components of project management server 200. Of course, specific functions performed by the components may differ from the functions performed by the identically-named components.

For example, communication port 330 may be used to transmit selections of representations, and to receive data comprising user interfaces. In this regard, input device 340 may be used by a manager to select displayed representations of process steps. Input device 340, display 350 and printer 360 may also be used in conjunction with other applications provided by manager device 300 which are unrelated to the present invention.

Data storage device 390 stores processor-executable process steps of Web browser 392. The process steps of Web browser 392 may be executed by microprocessor 310 to allow manager device 300 to send and receive information over the Web. More specifically, Web browser 392 allows manager device 300 to transmit information to and to receive information from a device executing process steps of a Web server, such as project management server 200.

Also stored in data storage device 390 are cookies 394. Cookies 394 are known in the art of Web communications, and are used to provide data concerning device 300 or concerning a manager operating device 300 to a Web server with which device 300 is in communication. The data may be used to determine whether the manager is authorized to receive particular Web pages from the Web browser, and/or to customize Web pages for presentation to the manager.

Data storage device 390 may also store application files, data files and system files other than those shown in FIG. 6. These files may be used to provide a manager with functions other than that provided by the present invention, such as e-mail functions, word processing functions, and the like. It should be noted that data storage device 390 may store all data and applications necessary to embody the present invention. In one example, data storage device 390 stores a word-processing application and documents, wherein the documents include user interfaces linked by representations according to embodiments of the present invention.

A tabular representation of a portion of project information database 294 is shown in FIG. 7. The portion includes several records, with each record consisting of several associated fields. The fields include step ID field 701, description field 702, level field 703, preceding step(s) field 704, following step(s) field 705, and instructions field 706. As described above, the information stored in project information database 294 may be received from any number of sources, such as from an external device over communication port 230 and from an operator using input device 240. Of course, the information may also be retrieved from removable media having the information stored thereon.

Step ID field 701 of a record specifies an identifier associated with a step that is the subject of the record. Description field 702 includes a description of the step that may be used to generate a representation of the step or to identify a step in a user interface such as that shown in FIG. 3. Additionally, level field 703 specifies a level of an associated step. For example, the steps represented in FIG. 1 are defined as level one steps, while substeps of each level one step are defined as level two steps, as represented in the second area of FIG. 2.

Preceding step(s) field 704 of a record identifies steps that immediately precede a step that is the subject of the record. Following step(s) field 705 similarly identifies steps that immediately follow the step that is the subject of the record. As shown, the preceding steps and the following steps are identified by their respective step IDs. The information of preceding step(s) field 704 and following step(s) field 705 may be used to construct diagrams of process steps such as those shown in FIGS. 1 through 3.

Instructions field 706 includes instructions associated with a step, such as instructions 46 of FIG. 3. As described above, the instructions may comprise notes, reminders, general instructions, detailed instructions, or any other information useful for performing an associated step.

Although FIG. 7 illustrates information related to process steps of a single project, it should be noted that more than one project may be reflected in project information database 294 of project management server 200. Such an arrangement is particularly useful in a case that project management server 200 provides project management functions to more than one manager and/or business. Moreover, It is contemplated that database 294 may include many more records than those shown and that each record may include associated fields other than those illustrated. It should also be noted that the tabular illustration and accompanying description merely represent relationships between stored information. A number of other arrangements may be employed besides the one suggested.

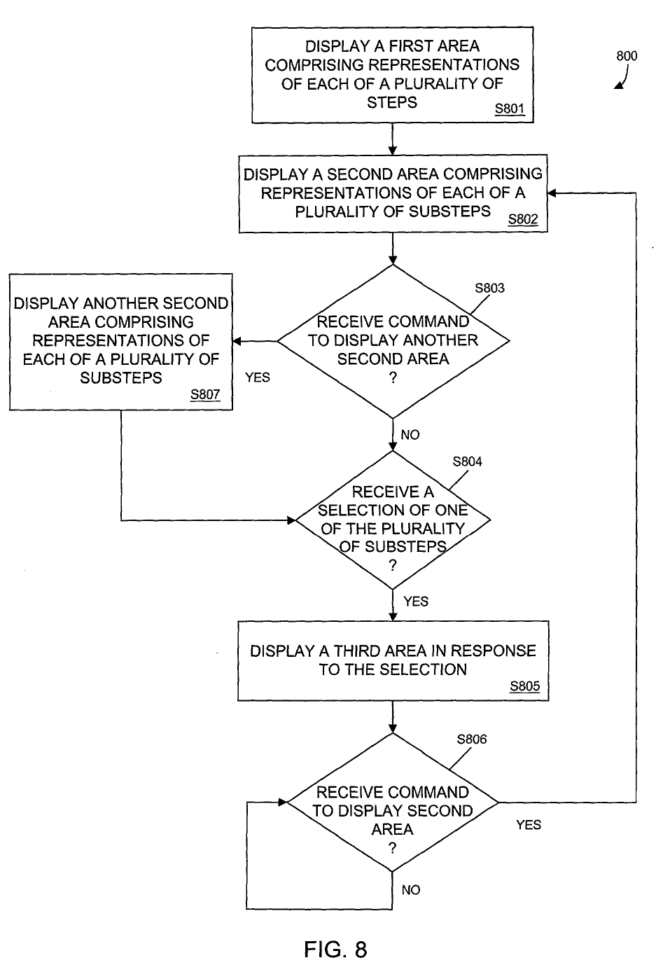

FIG. 8 comprises a flow diagram of process steps 800 for facilitating project management according to embodiments of the present invention. As described below, process steps 800 may be embodied, in whole or in part, in project management server, manager device 300 and another device.

Initially, in step S801, a first area is displayed. The displayed first area comprises representations of each of a plurality of steps. Step S801 may be executed in response to a request received from a manager to view process steps of a particular project. More specifically, the manager may operate input device 340 of manager device 300 to execute process steps of a word processing application so as to open a document related to the particular project. The document may be stored in data storage device 390, data storage device 290 or in another device with which manager device is in communication. In some embodiments of step S801, the document includes a user interface having a first area comprising representations of each of a plurality of steps. As described above, such a first area is shown in the user interfaces of FIG. 1 and FIG. 2.

In some embodiments, the manager operates input device 340 to execute process steps of process Web browser 392 prior to step S801. Also prior to step S801, input device 340 is used to input an address of a website associated with a Web server executing within project management server 200. Process steps of Web browser 392 are executed to transmit a query to the website, and, in step S801, the website transmits a Web page to manager device 300 including a first area comprising representations of each of a plurality of steps. In either of the above embodiments, the document or Web page may be accessible only over an intranet to which both manager device 300 and project management server 200 belong, over the Web via a secure protocol, or over another network type. Cookies 394 or password protection may be used to assure that the manager is an authorized recipient of the document or Web page.

The foregoing document or Web page may be generated prior to step S801 or during execution of process steps 800 by project management server 200 or by manager device 300. In one example, the information stored in project information database 294 is used to create all interfaces for a particular project prior to step S801. In another example, the information is used to generate a required interface on-the-fly in response to a selection or a command received from the manager.

As mentioned above, the first area included in the received document or Web page is displayed in step S801. The term “display” as used herein encompasses at least one of output of the first area using a display or printer such as display 350, display 250, printer 360 and display 360, and transmission of data comprising the first area from one device, such as project management server 200 to another device, such as manager device 300.

A second area comprising representations of each of a plurality of substeps is displayed in step S802. The second area may be displayed in response to a selection of a representation of a step from the first area. In one example of this embodiment, the manager operates input device 340 to select representation 11 of Requirements step 1.0 from the FIG.1 interface and the user interface of FIG. 2 is displayed in response to the selection. In such a case, representation 11 may comprise an object including a link to the FIG. 2 user interface.

In some embodiments, step S801 and step S802 occur simultaneously. For example, the user interface of FIG. 2 includes both the first area and the second area described in steps S801 and S802. Accordingly, each of these steps may be performed simply by displaying the FIG. 2 interface.

It is then determined, in step S803, whether a command has been received to display another second area comprising representations of each of a plurality of substeps. If such a command has not been received, flow continues to step S804, wherein it is determined whether a selection of one of the displayed plurality of substeps has been received. If such a selection has not been received, flow returns to step S803. Therefore, flow cycles between step S803 and step S804 until either a command is received to display another second area or a selection of one of the displayed plurality of substeps is received.

For the present example, it is assumed that a selection of one of the displayed plurality of substeps is received in step S804. As mentioned above, selection of a representation of a step or a substep is deemed to be also a selection of the step or the substep. The selection may be input by a manager using input device 340 prior to step S804. In response to the selection, a third area is displayed in step S805. The third area comprises a representation of the selected substep, representations of at least one and less than all of the substeps preceding the selected substep, representations of at least one and less than all of the substeps following the selected substep, and instructions for performing the selected substep. FIG. 3 shows a third area that may be displayed in step S805 in response to a selection of representation 31 that is received in step S804. Again, the area of FIG. 3 is displayed because selected representation 31 comprises an object including a link to the FIG. 3 user interface.

Flow pauses at step S806 until a command is received to re-display the second area. In some embodiments of the present example, the command is received once the manager selects graphic 50, which comprises a link to the user interface of FIG. 2. Flow then returns to step S802, in which the FIG. 2 interface is displayed.

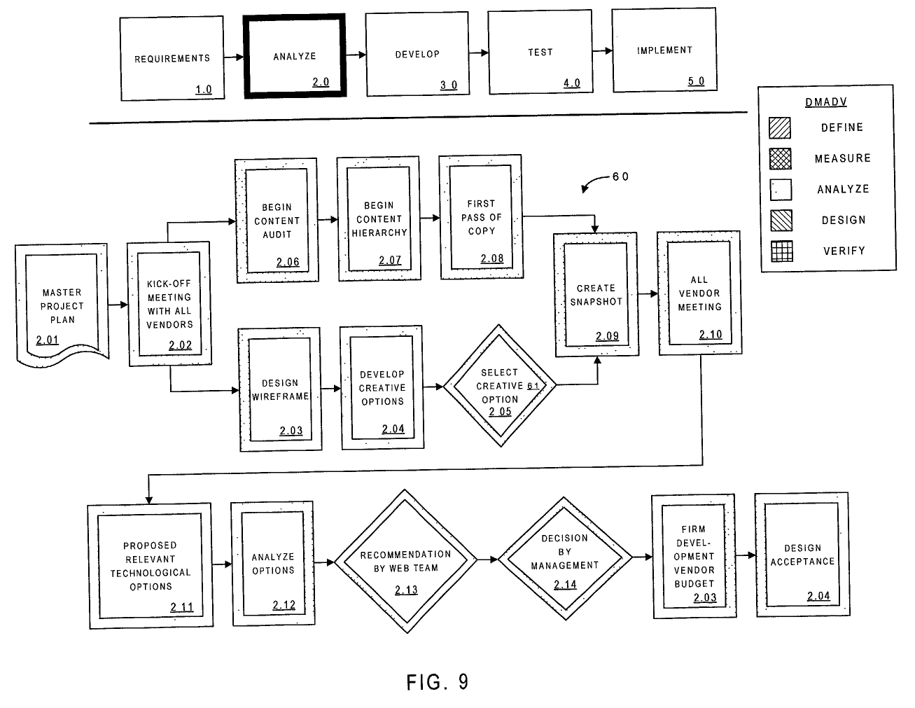

Upon returning to step S803, it is assumed that a command is received to display another second area. Such a command may comprise a selection by the manager of a representation of one of process steps 10 that is different from the previously-selected representation. For example, a selection of representation 12 of Analyze step 2.0 may be received in step S803. Another second area, such as that shown in FIG. 9, is then displayed in step S807. As shown in FIG. 9, the selected representation is displayed in a first area so as to indicate that representations 60 represent substeps of the step represented by the selected representation.

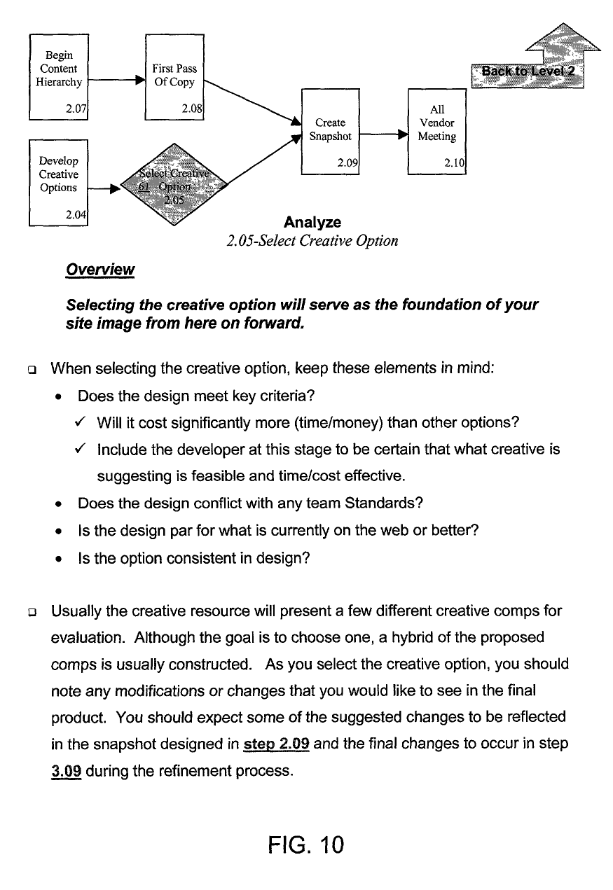

Flow then proceeds to step S804, wherein a selection of step 2.05 of FIG. 9 is received. In response to the selection, the user interface of FIG. 10 may be displayed in step S805. Similarly to the user interface of FIG. 3, the user interface of FIG. 10 includes a representation of the selected substep, representations of at least one and less than all of the substeps preceding the selected substep, representations of at least one and less than all of the substeps following the selected substep, and instructions for performing the selected substep. Flow then pauses at step S806 until a command is received to re-display the second area of FIG. 9.

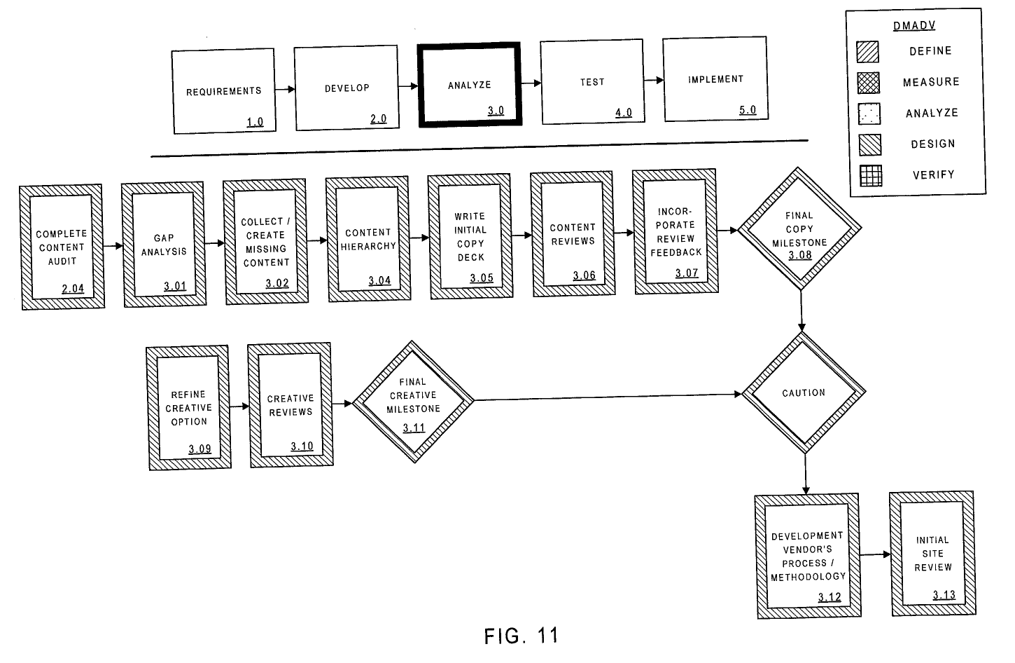

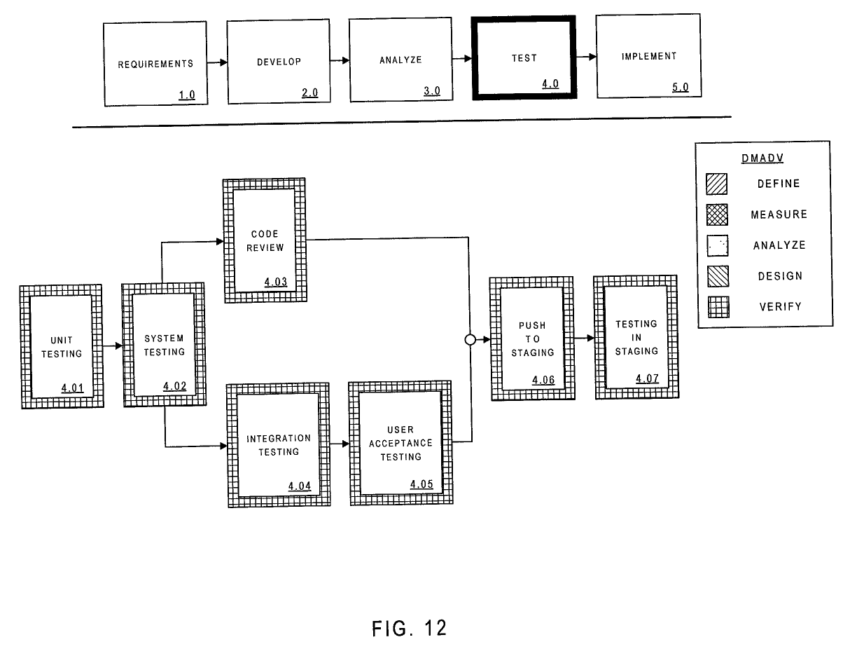

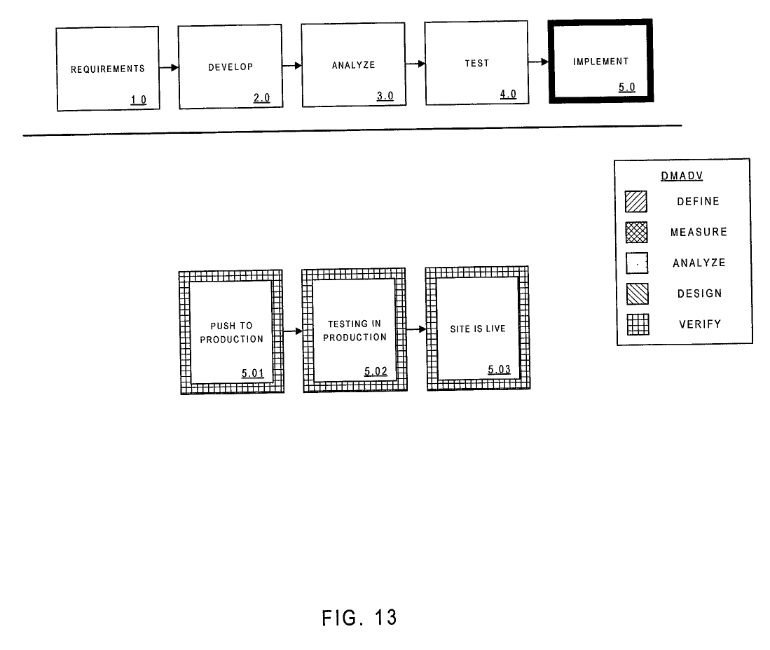

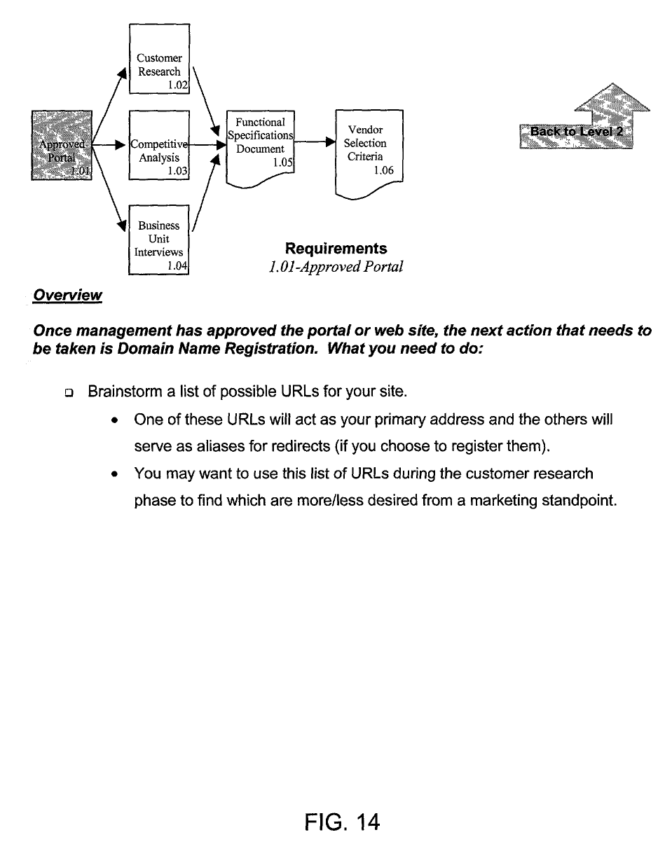

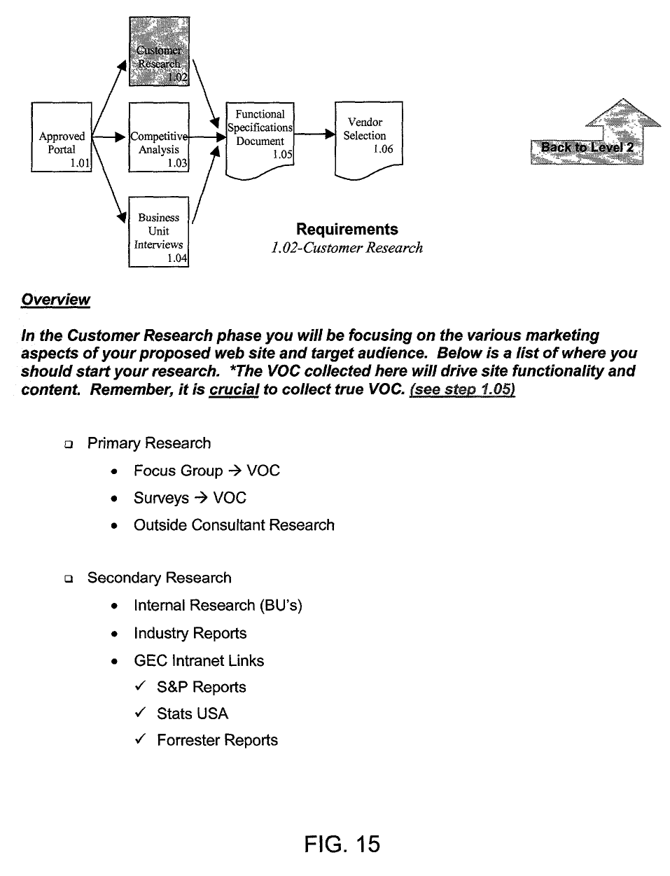

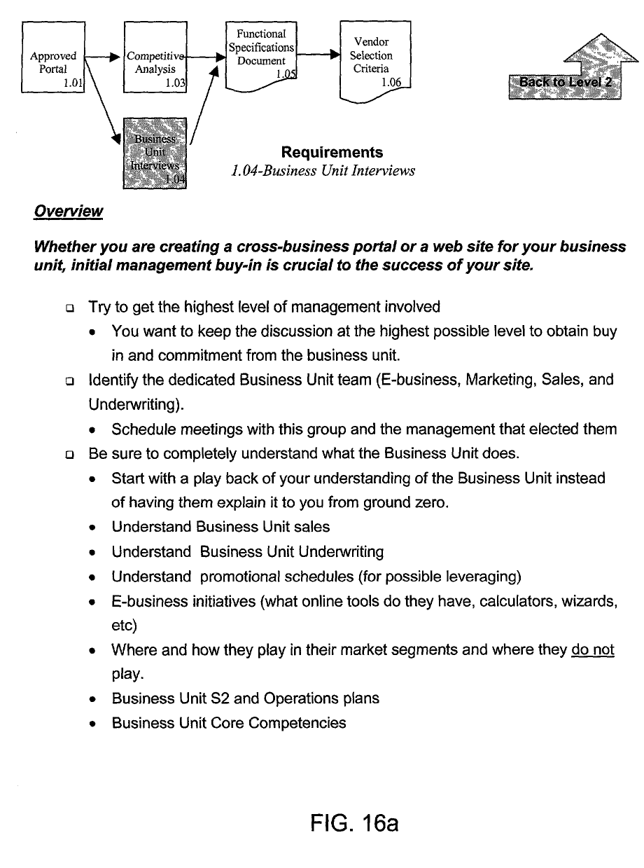

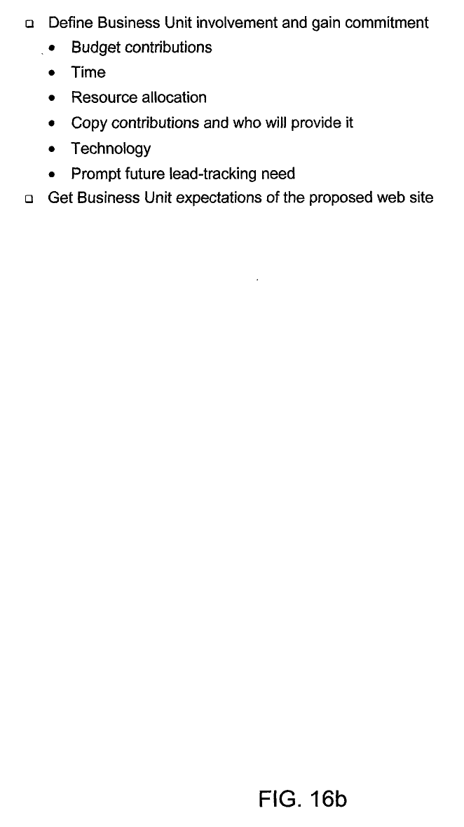

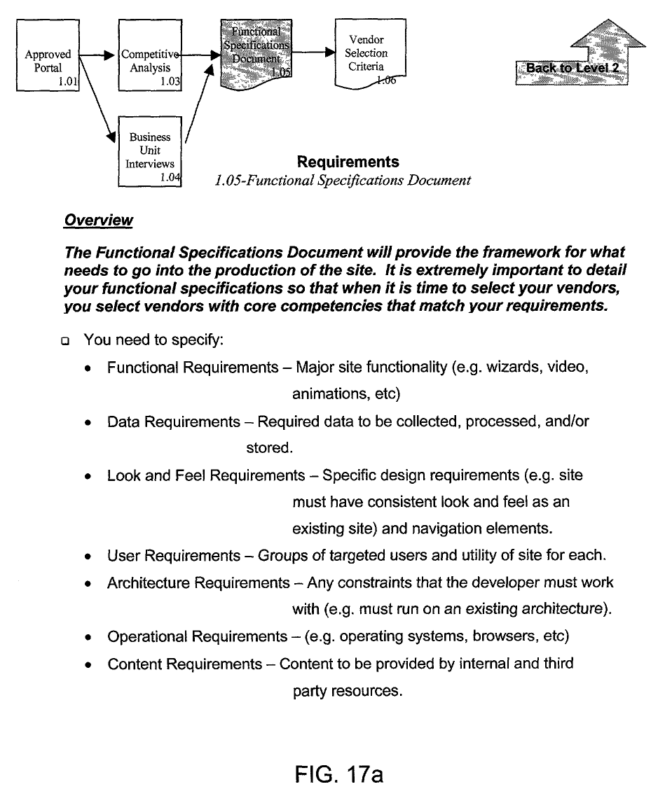

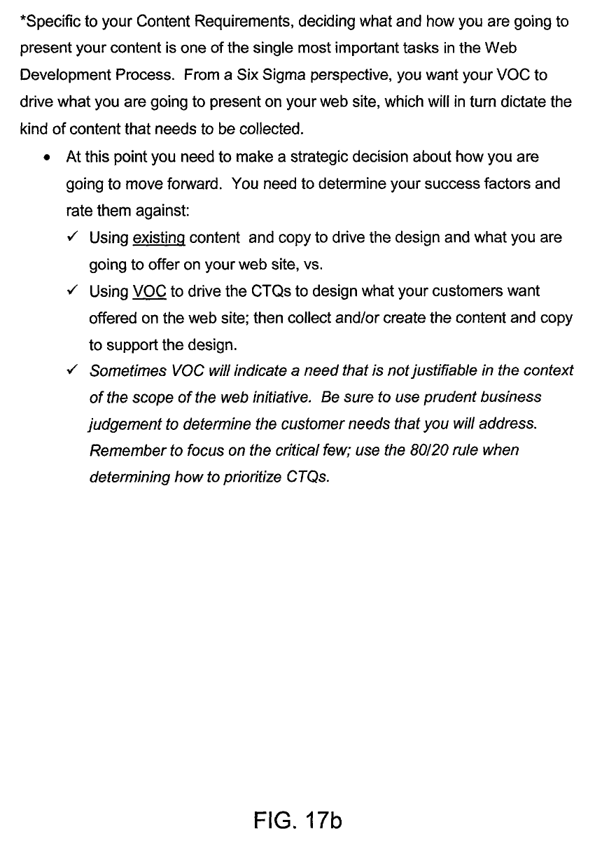

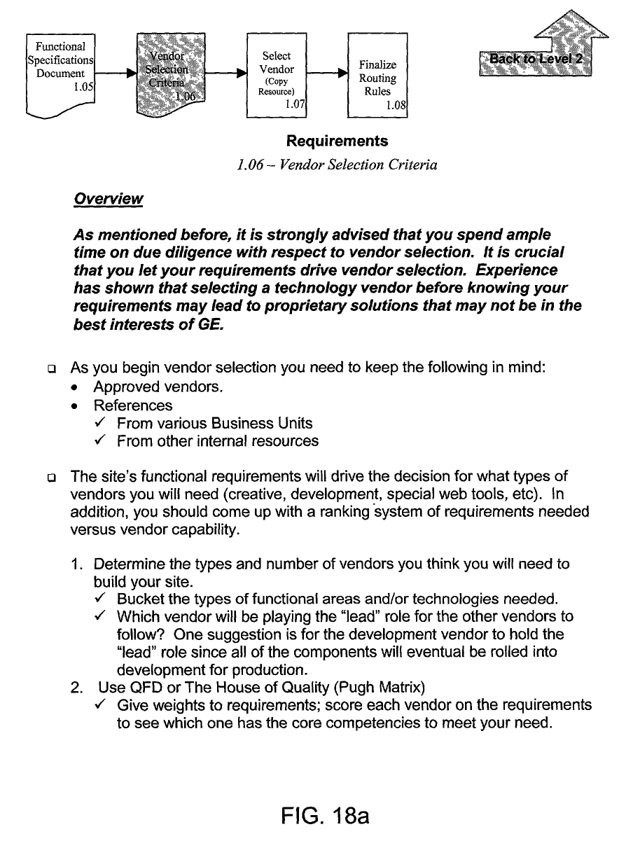

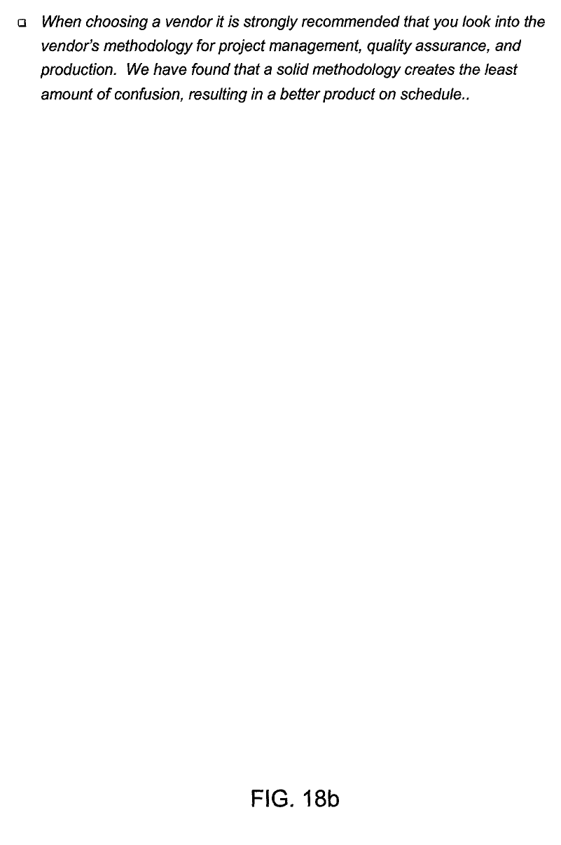

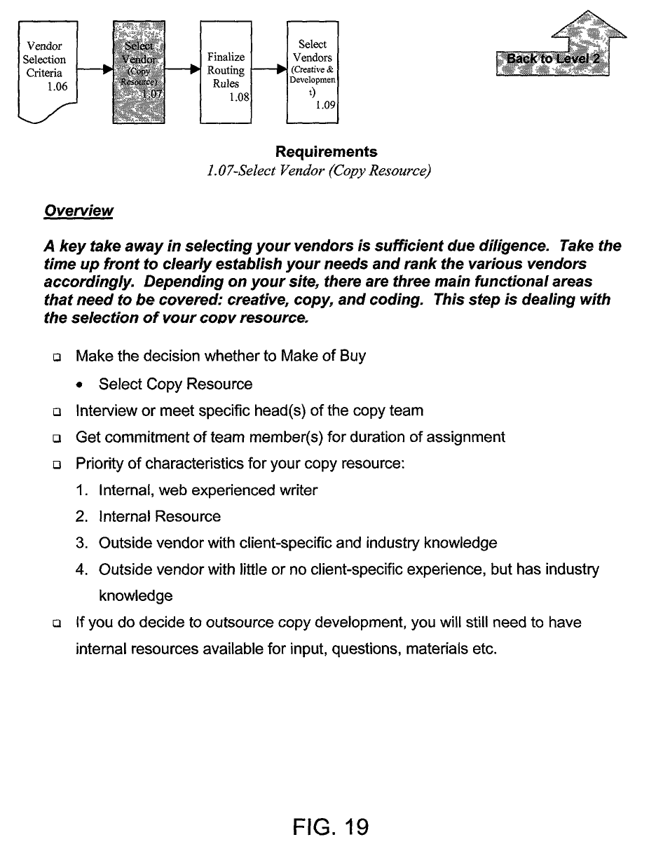

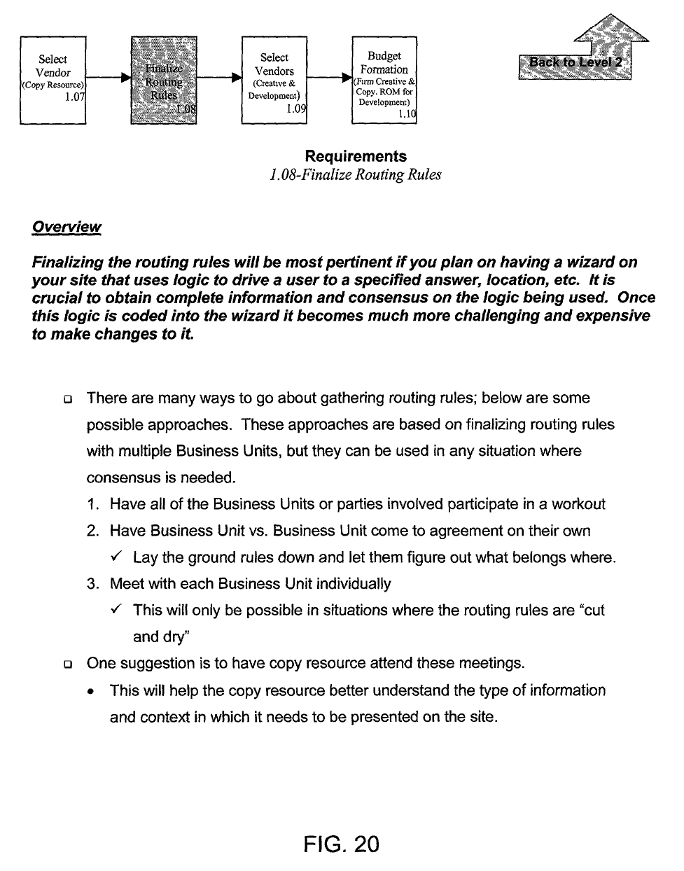

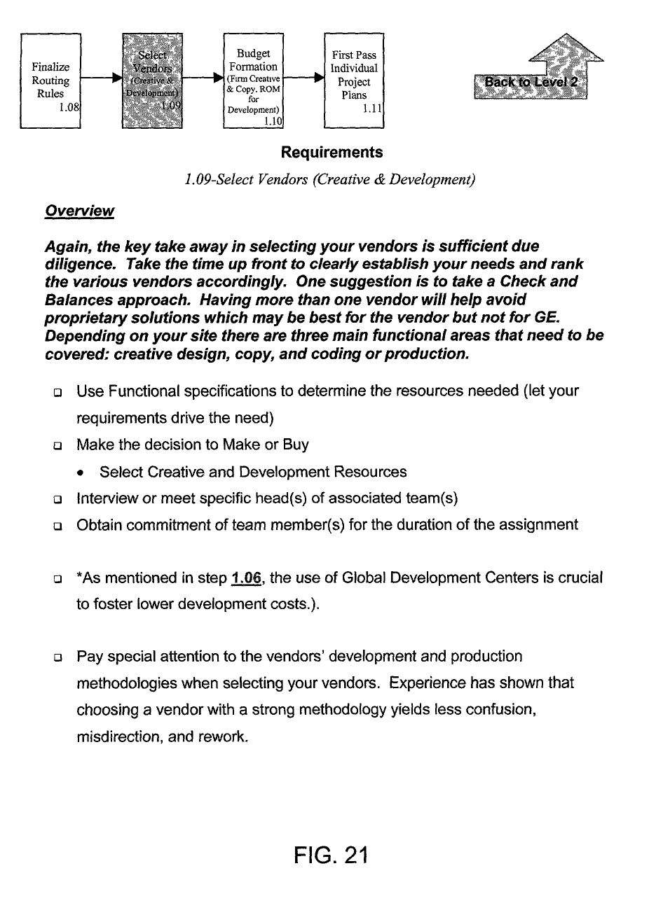

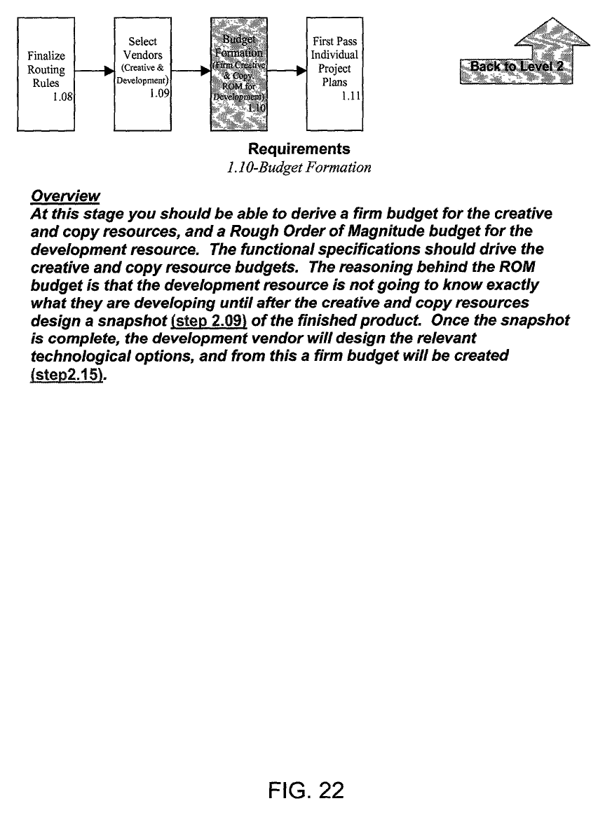

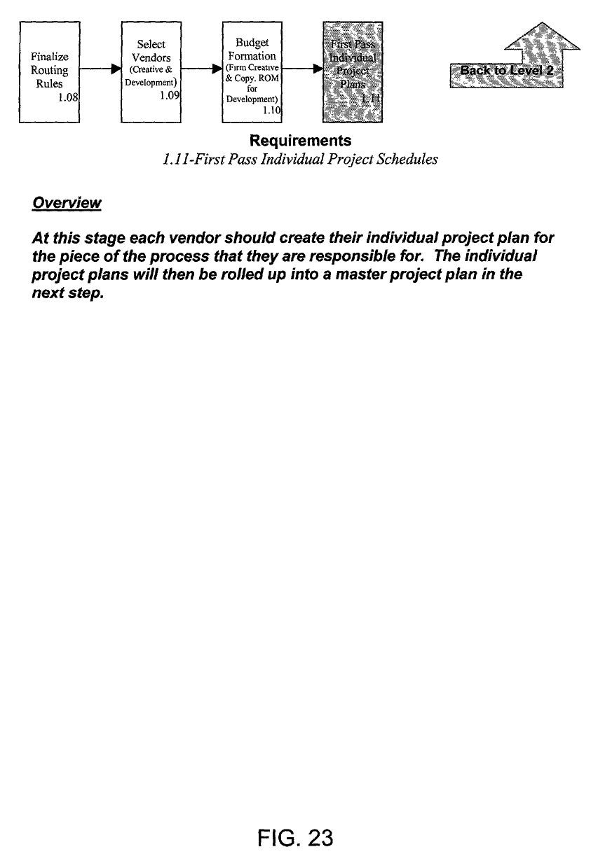

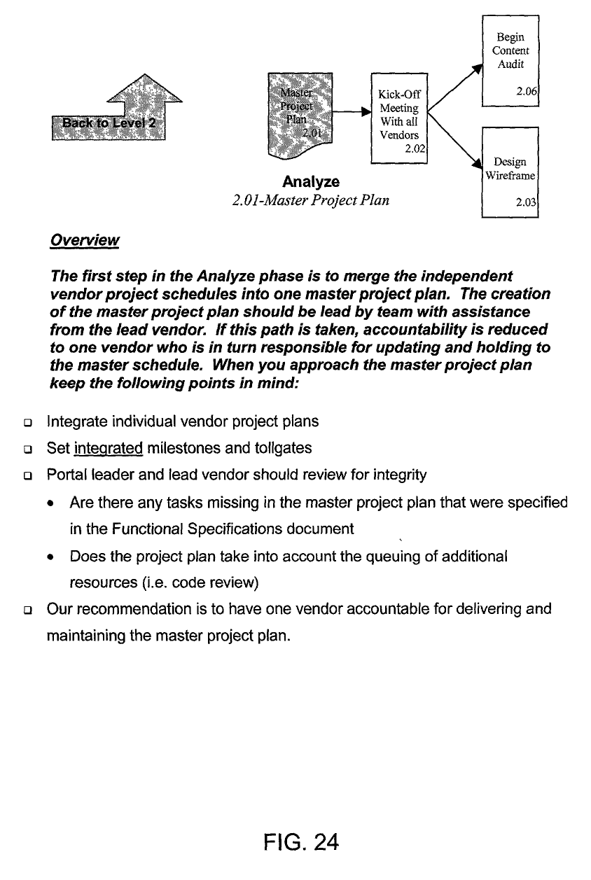

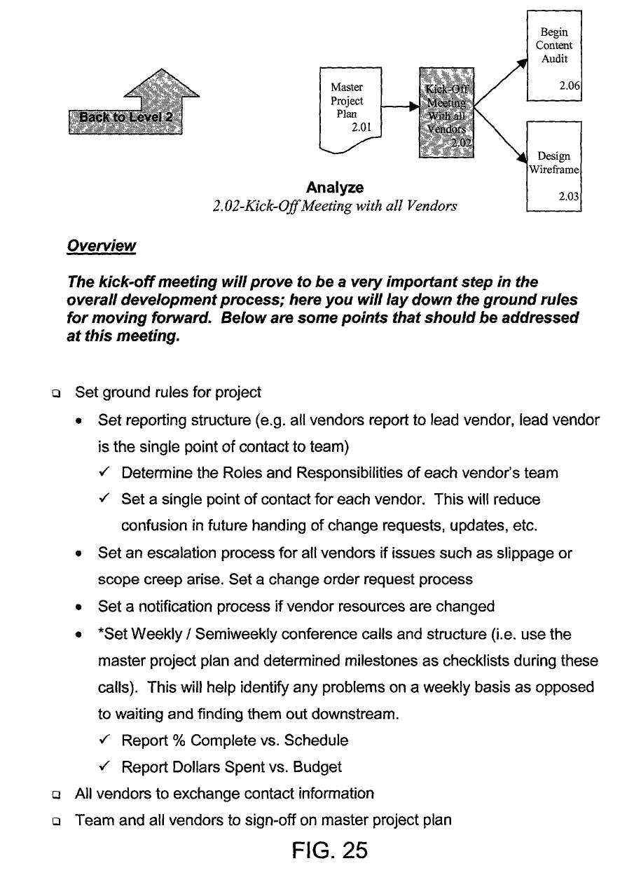

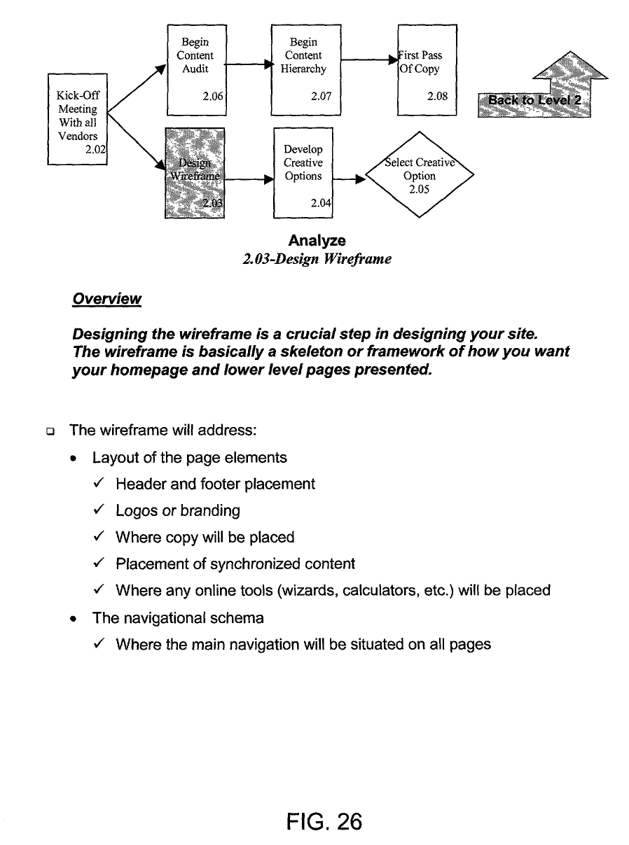

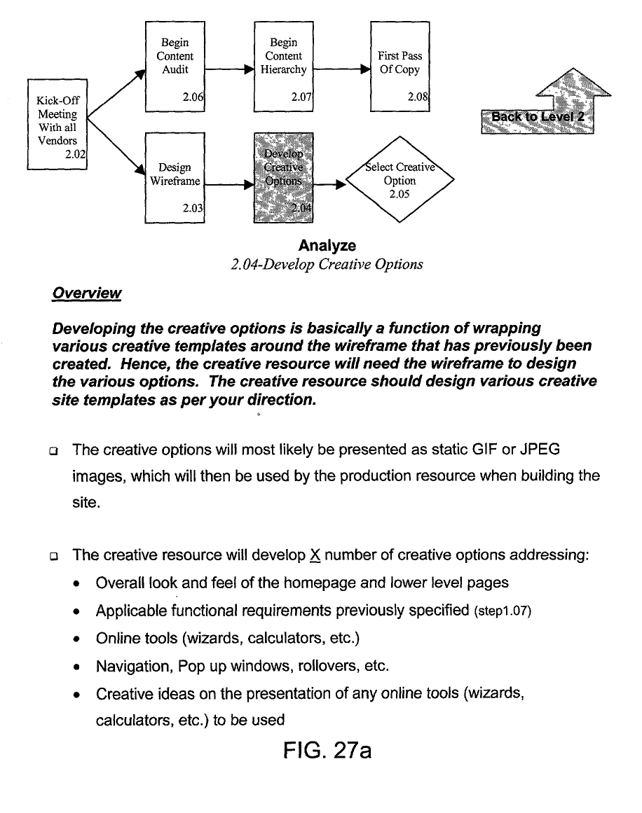

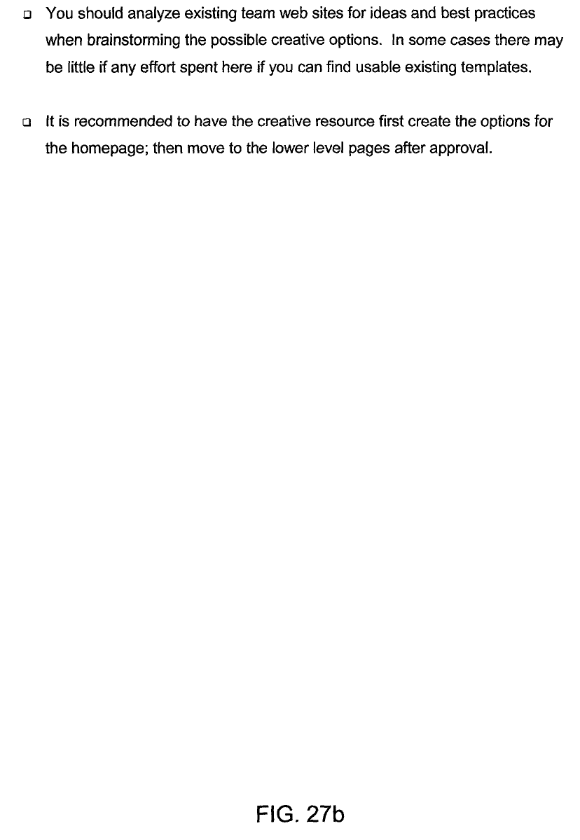

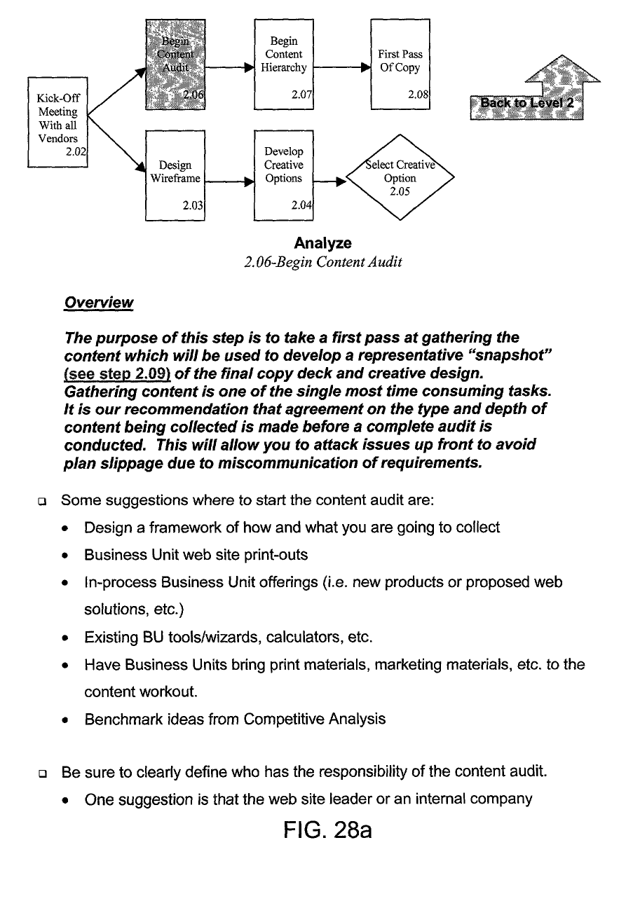

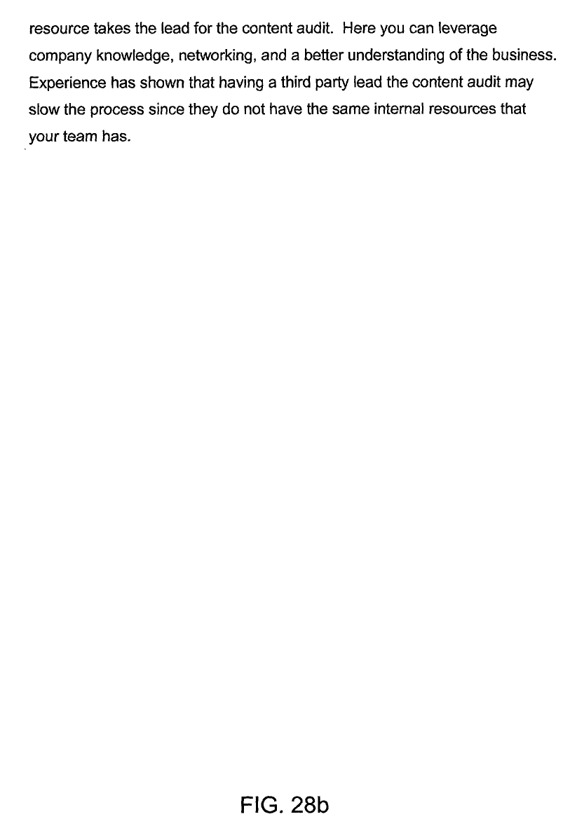

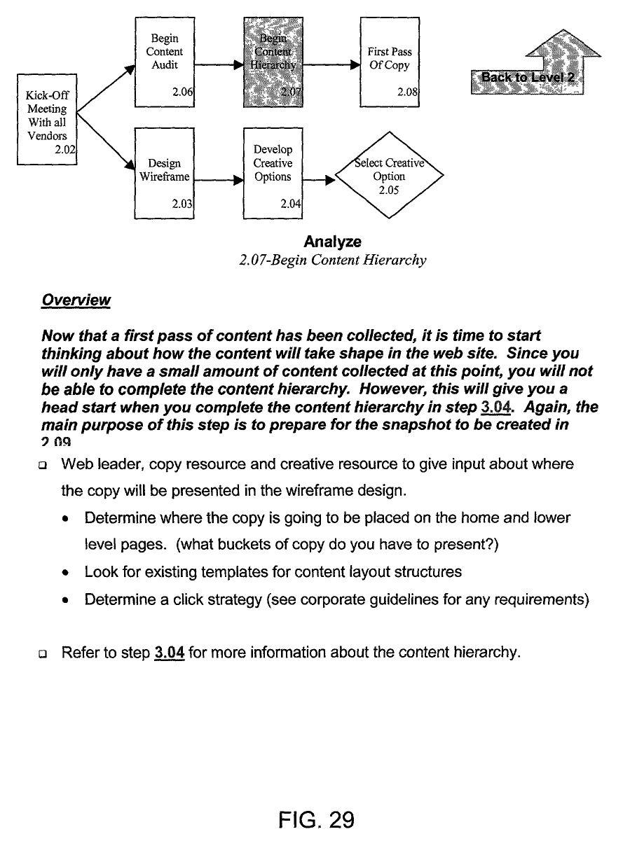

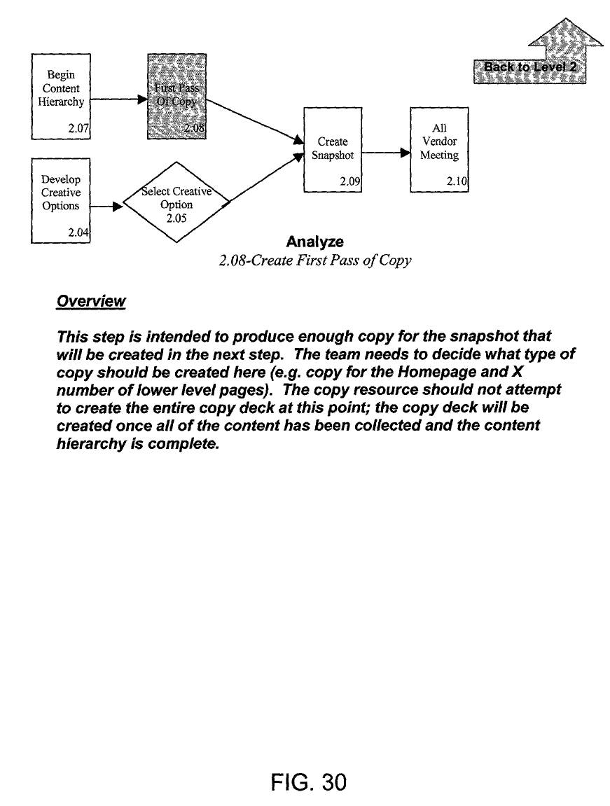

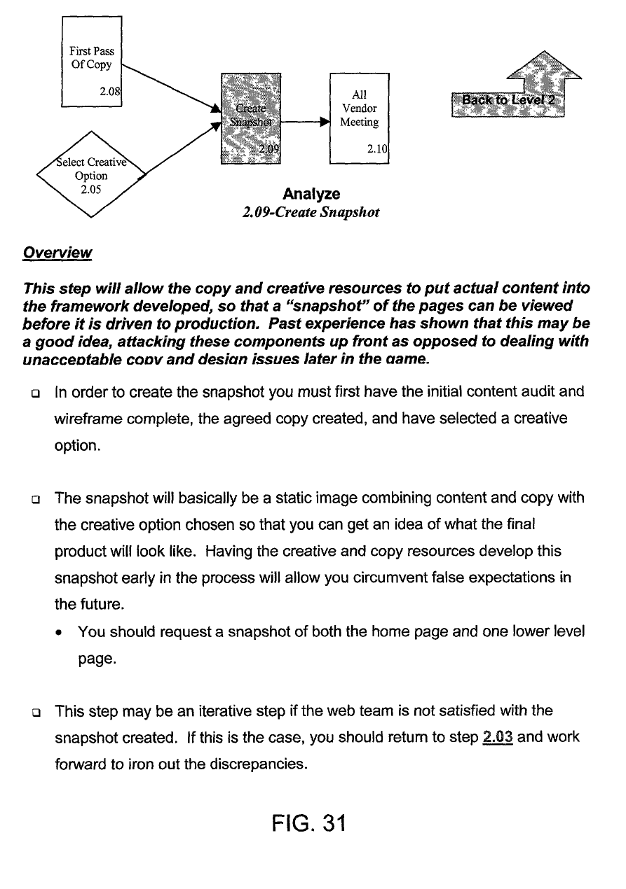

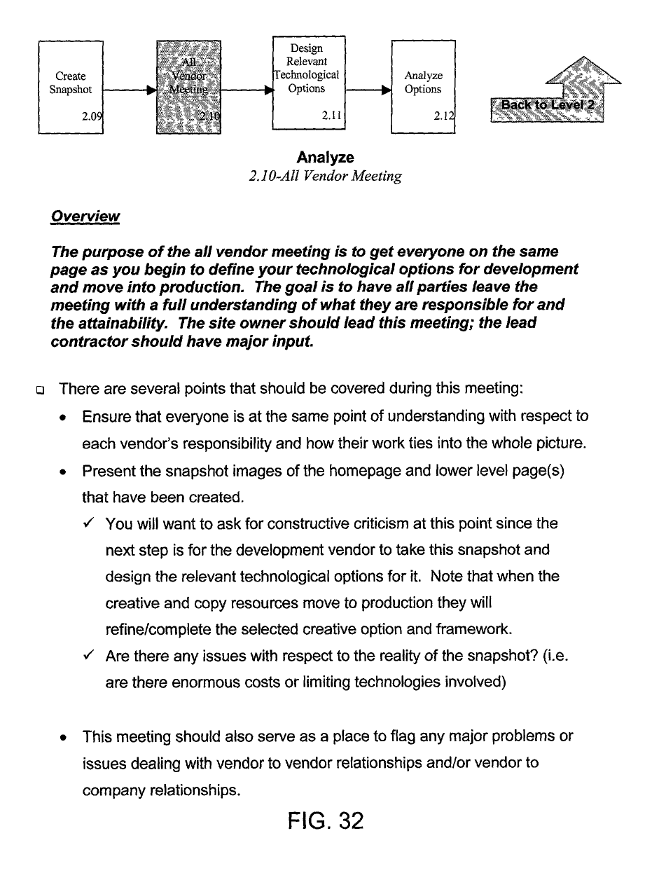

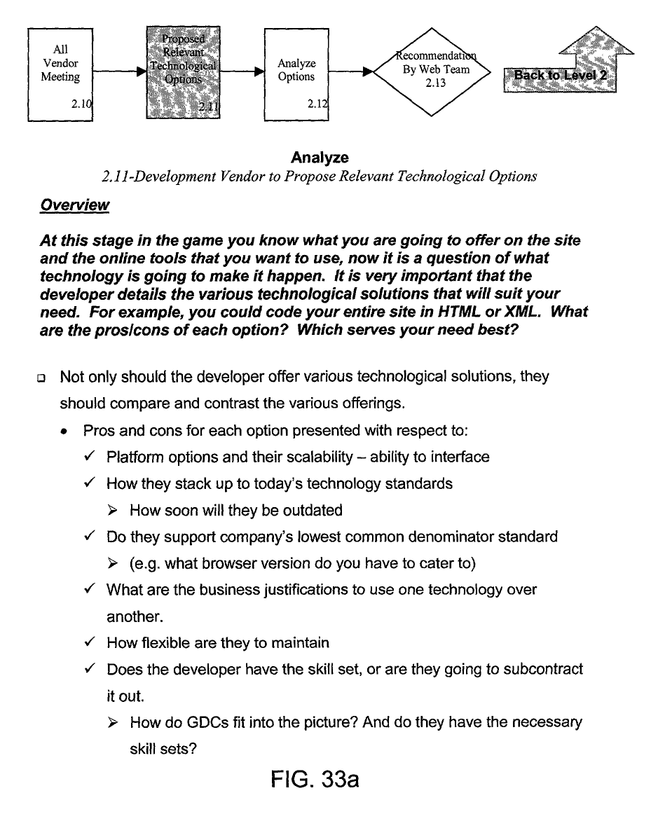

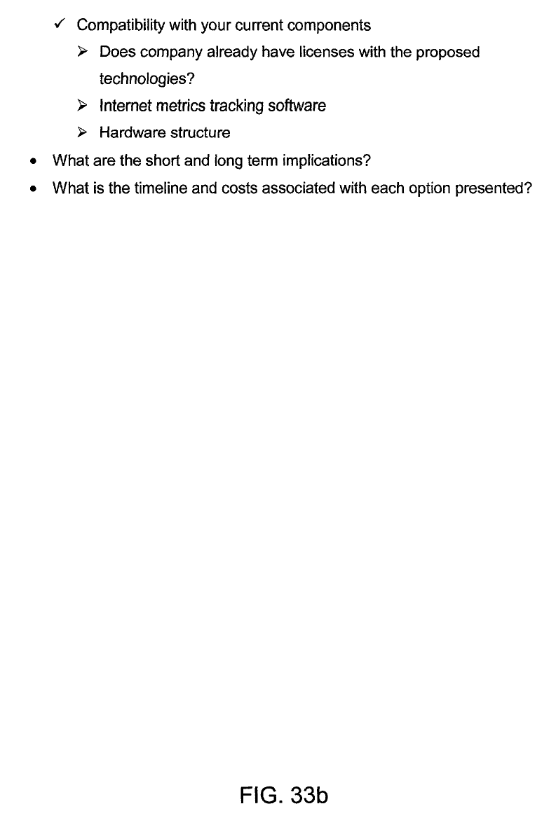

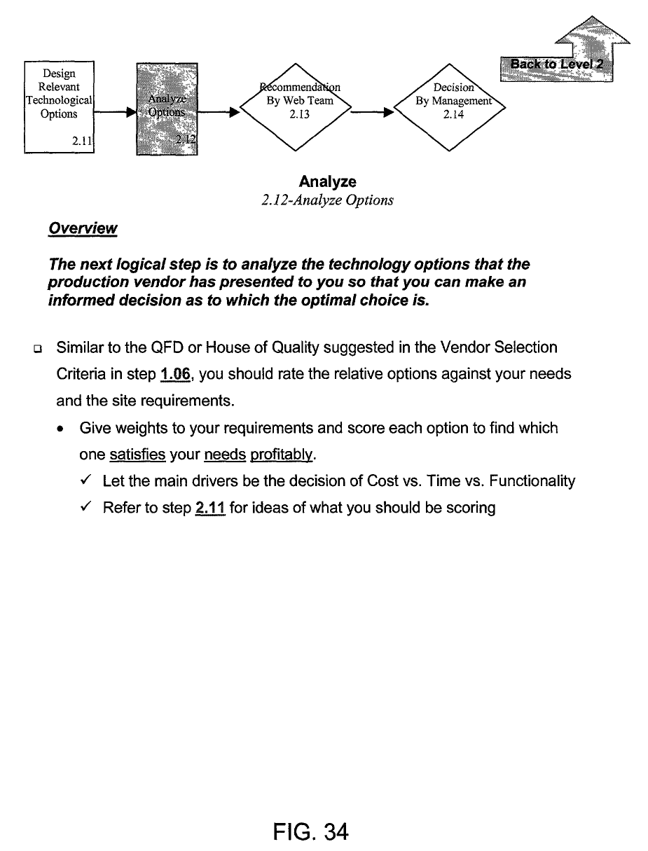

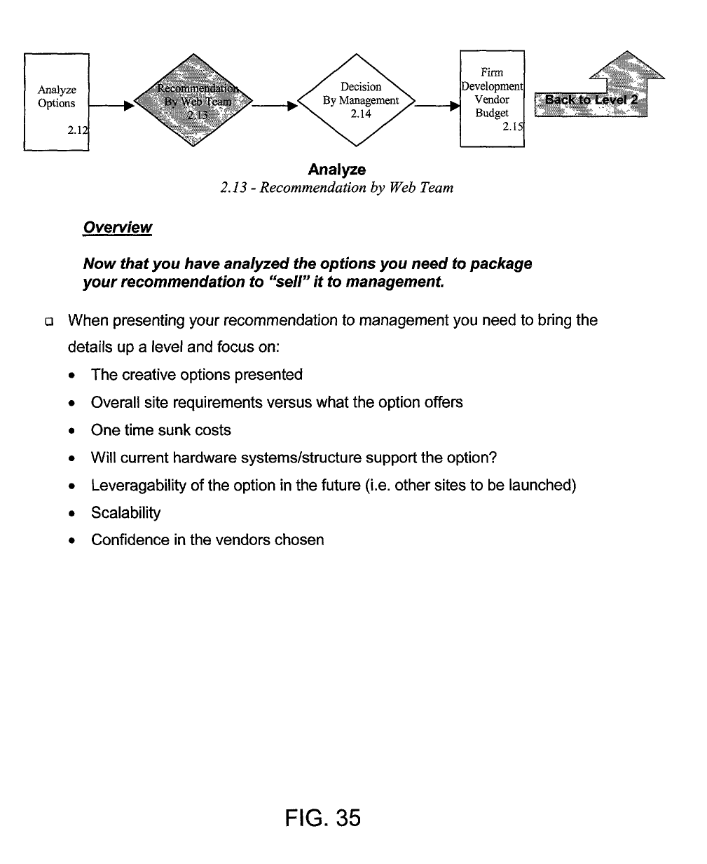

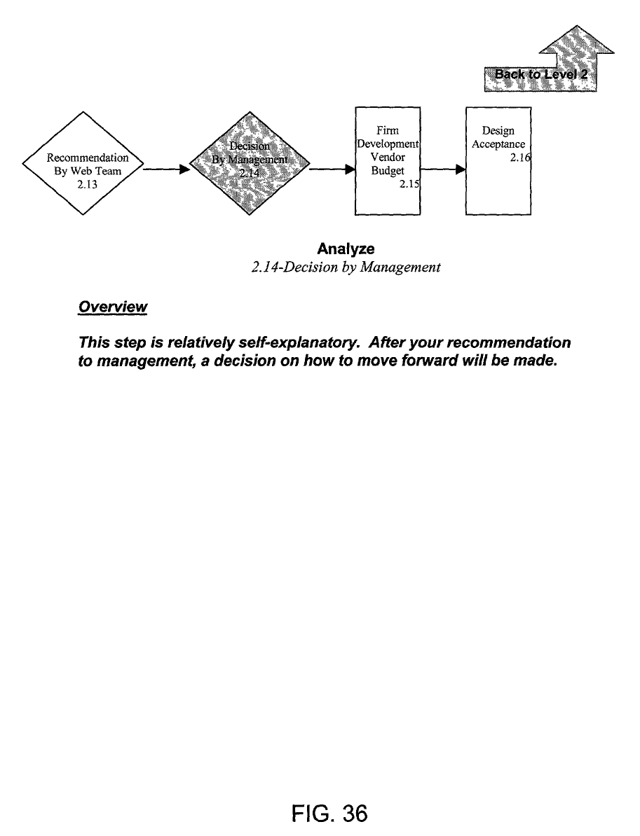

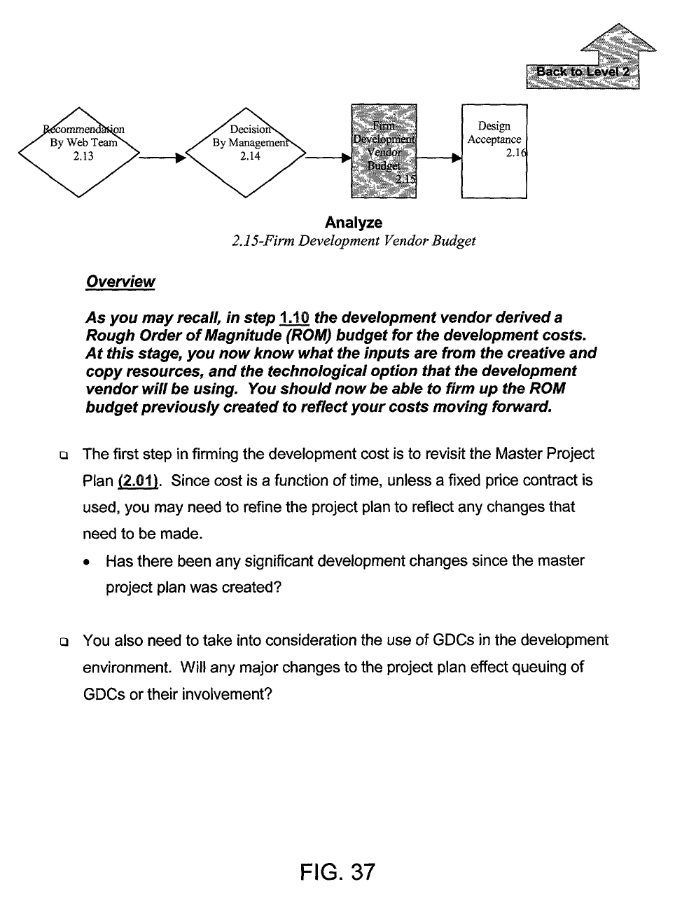

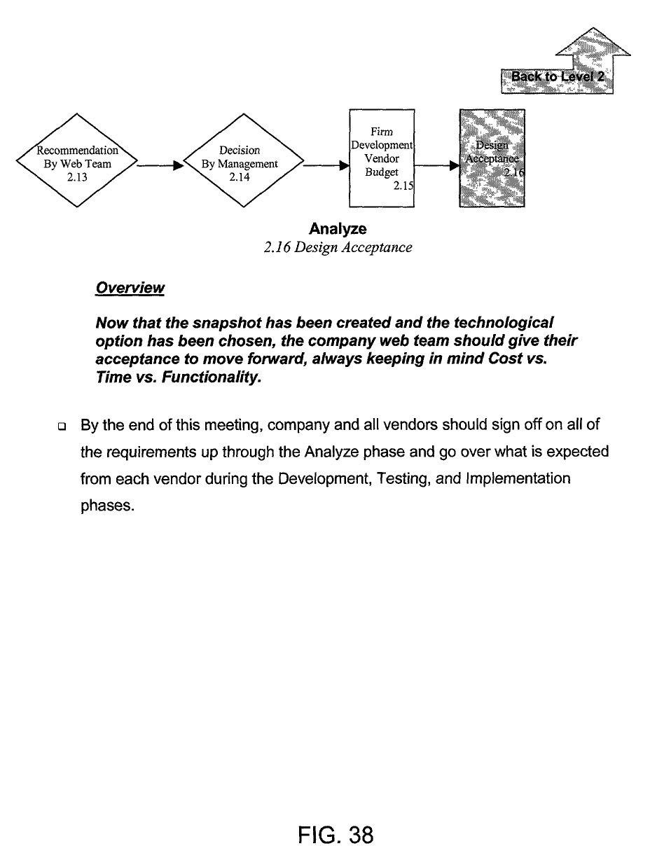

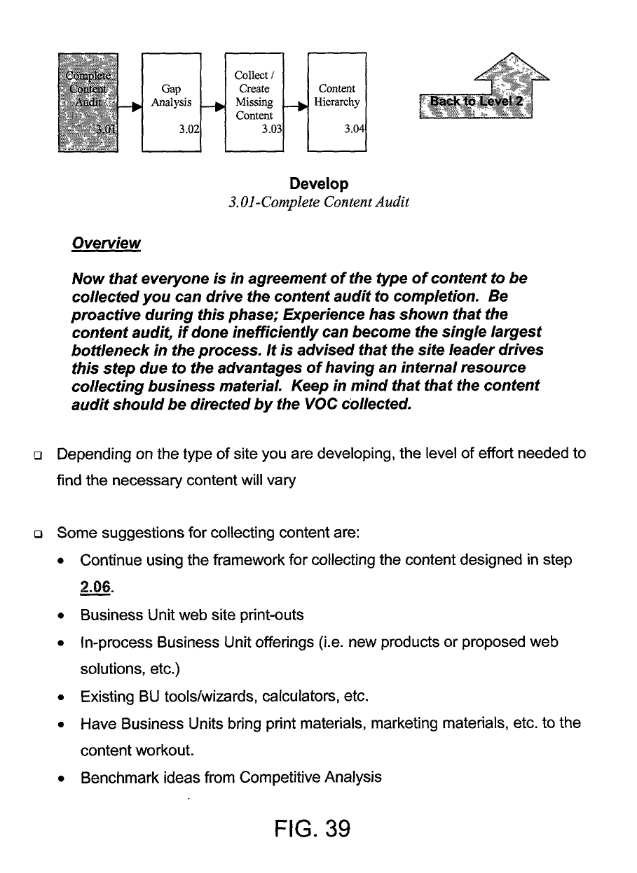

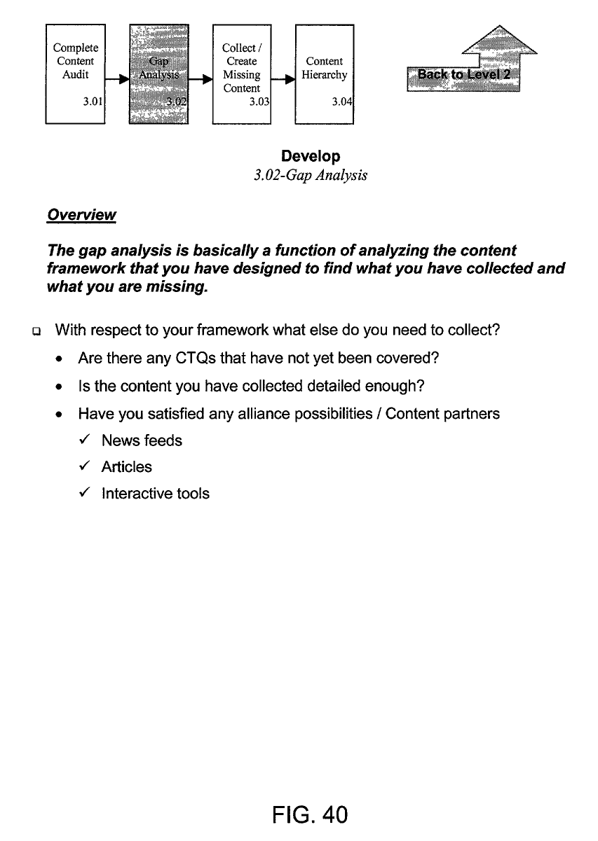

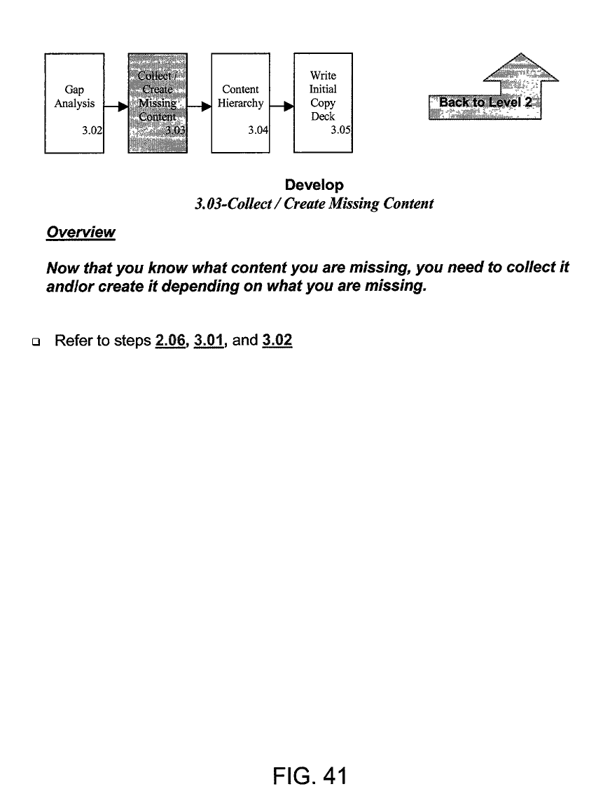

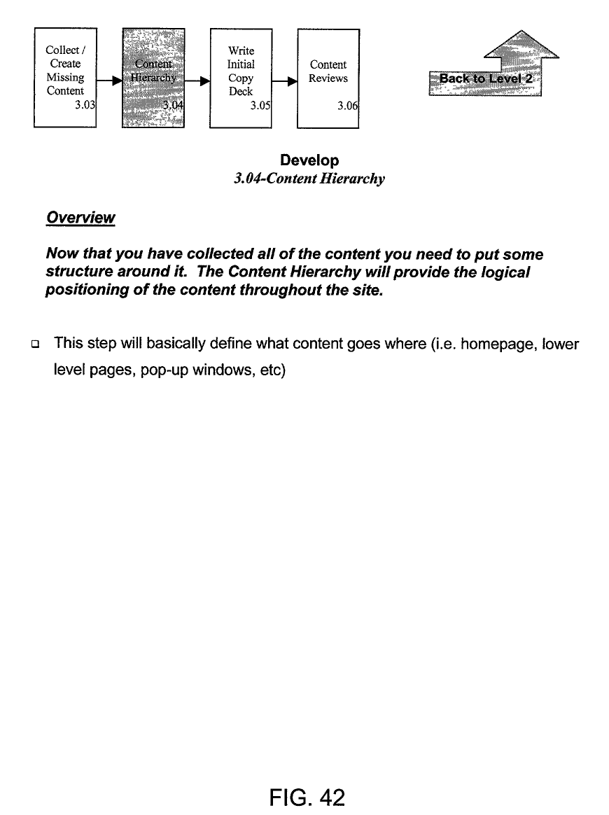

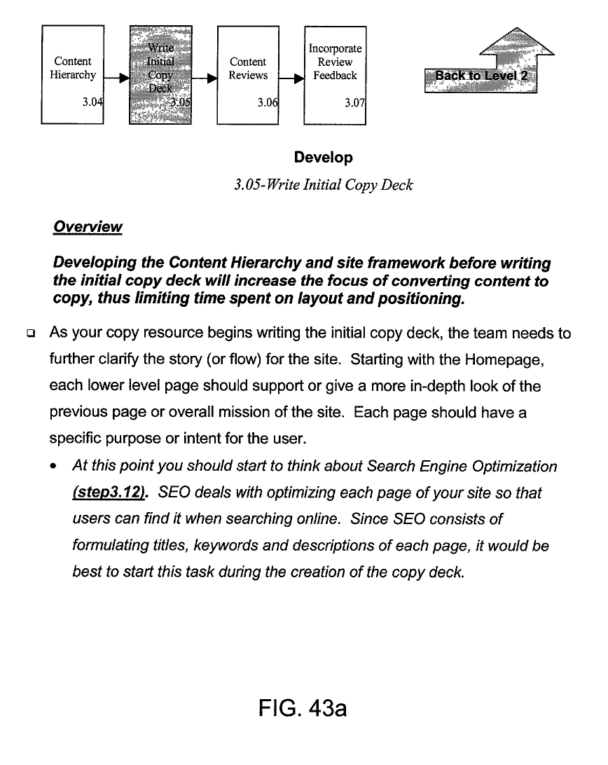

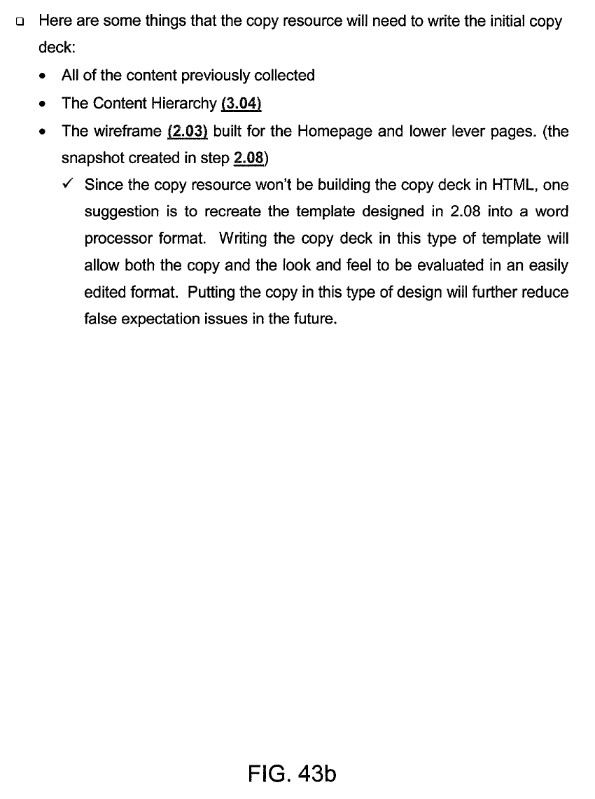

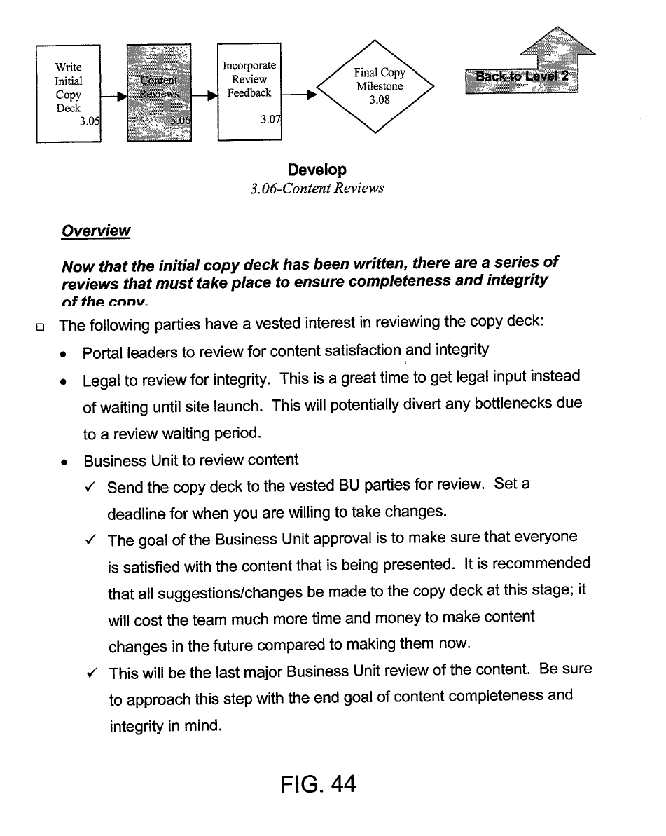

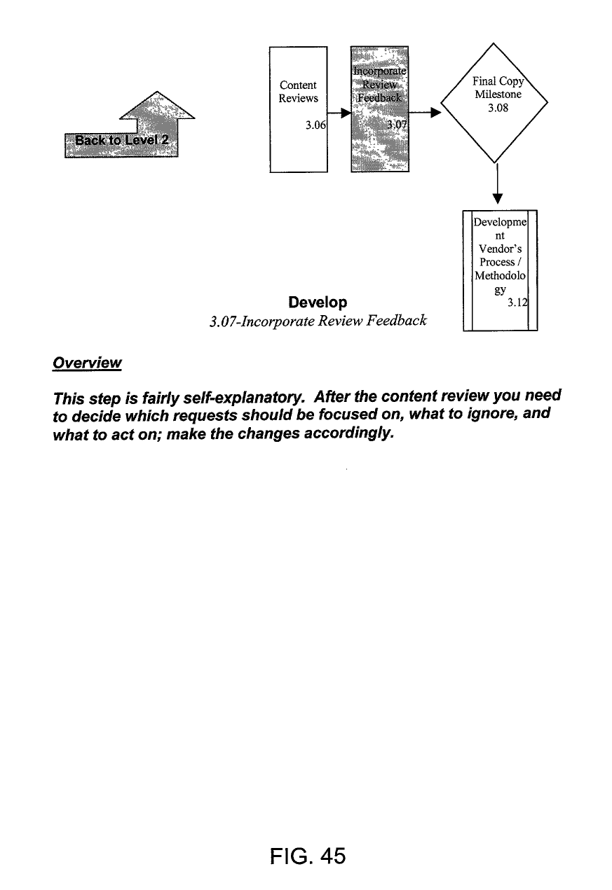

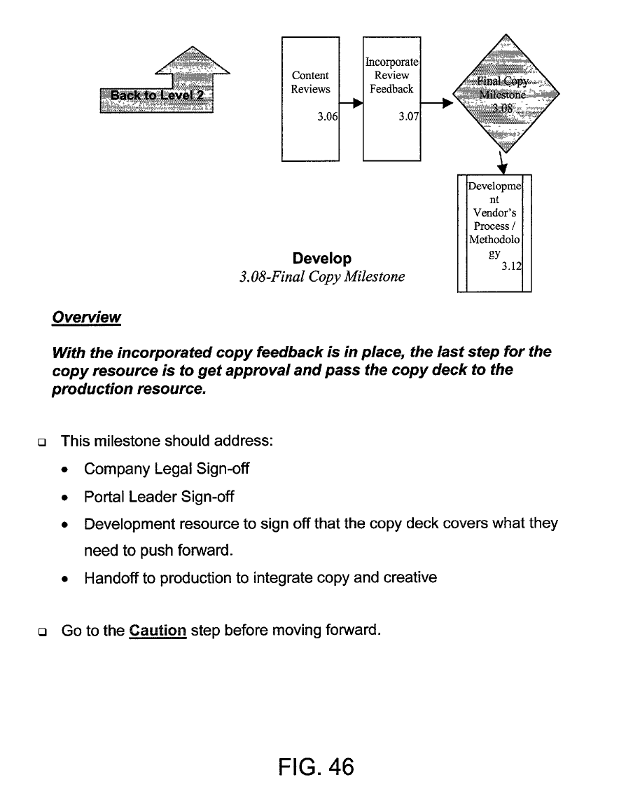

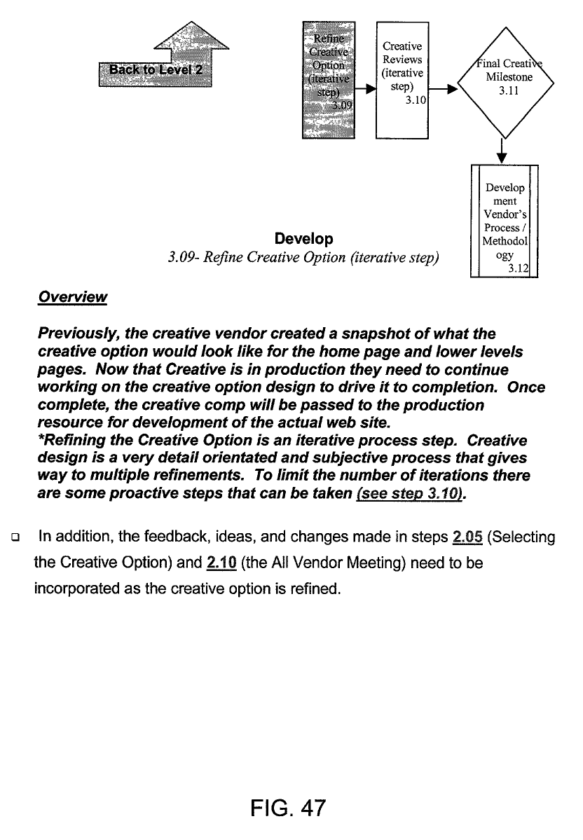

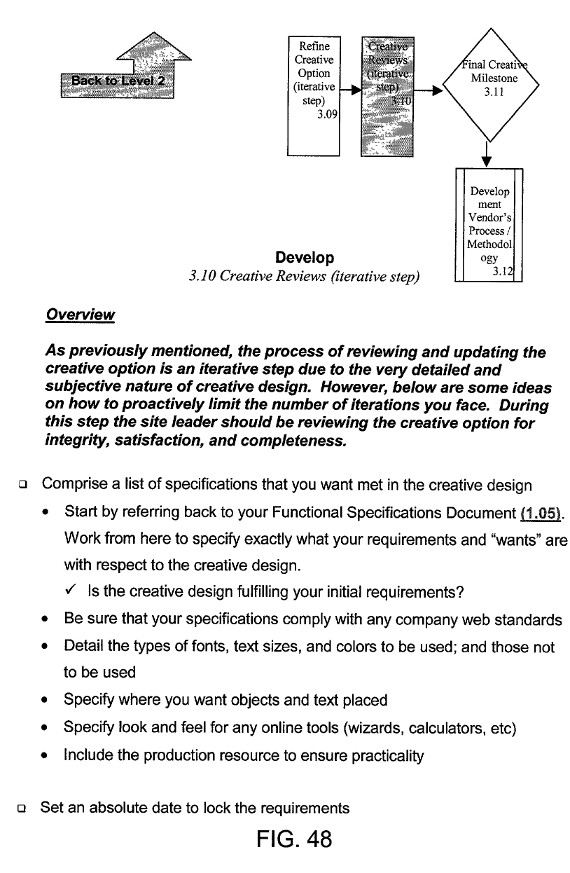

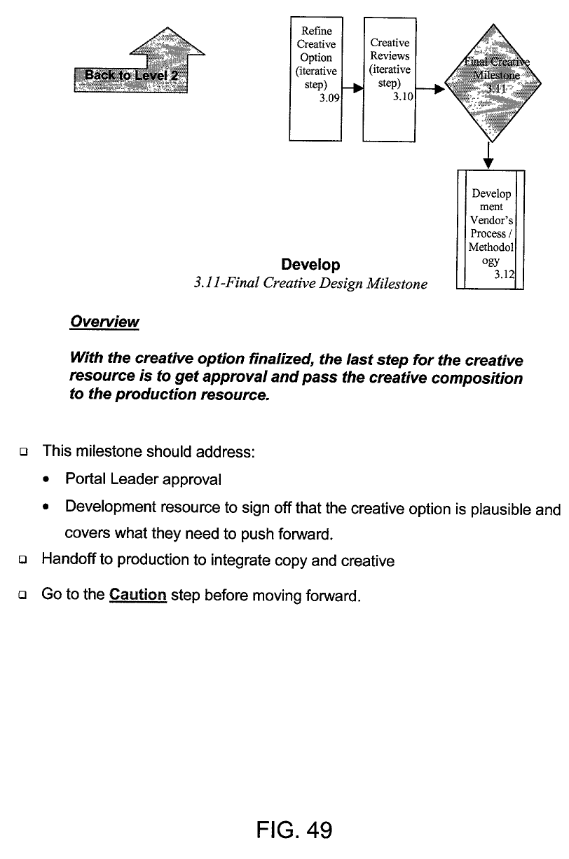

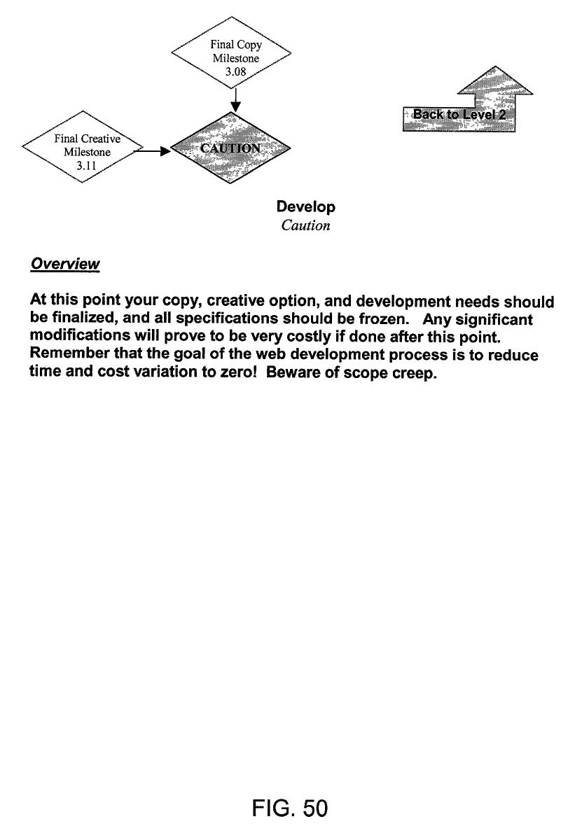

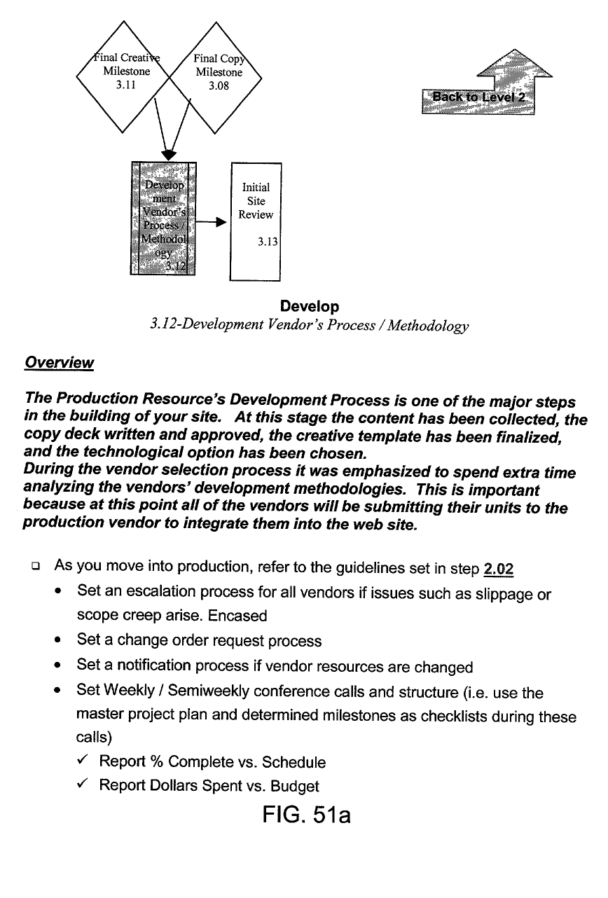

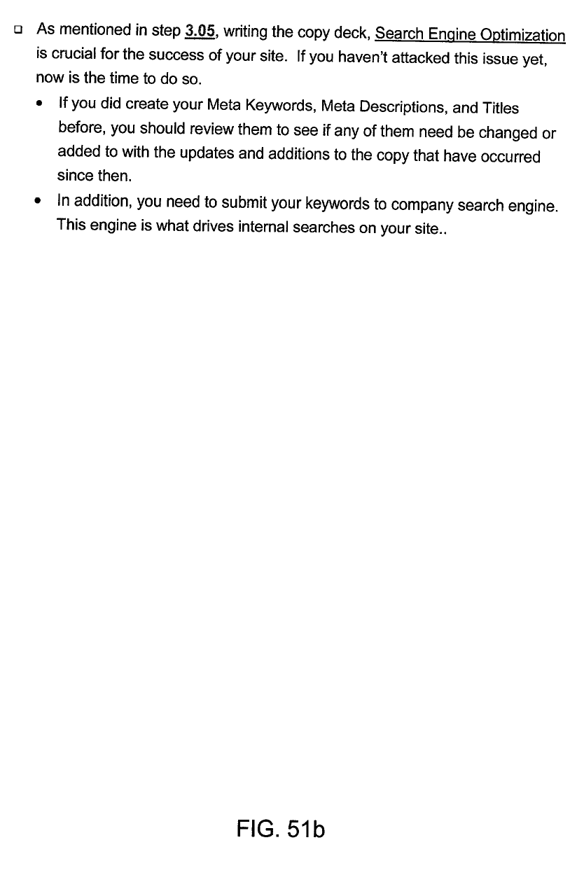

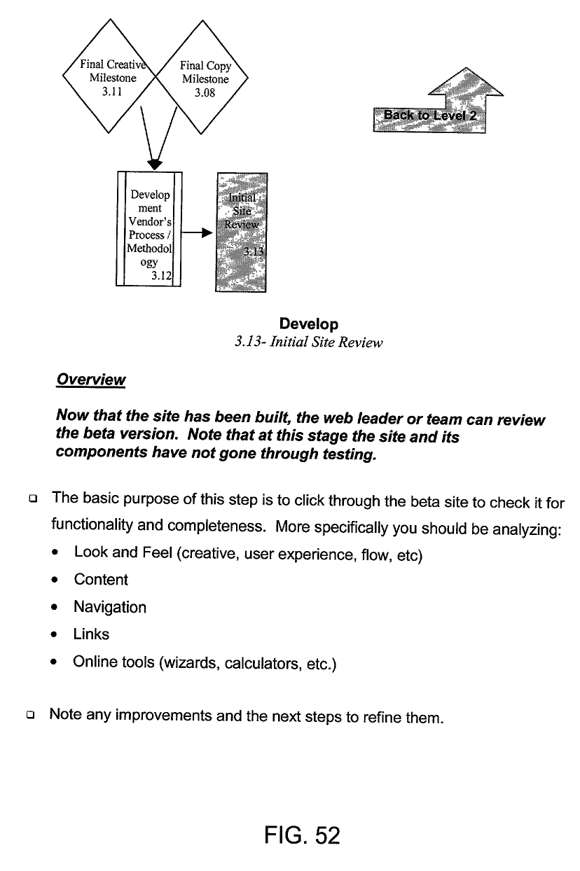

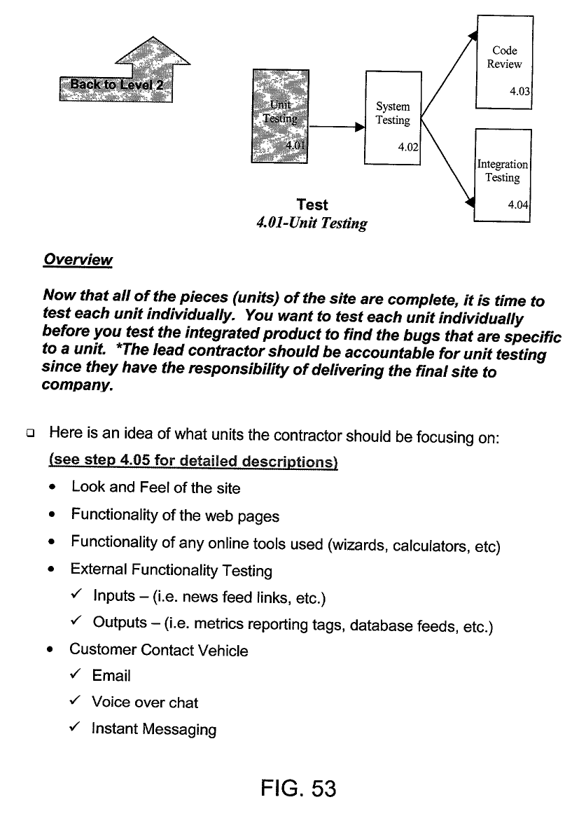

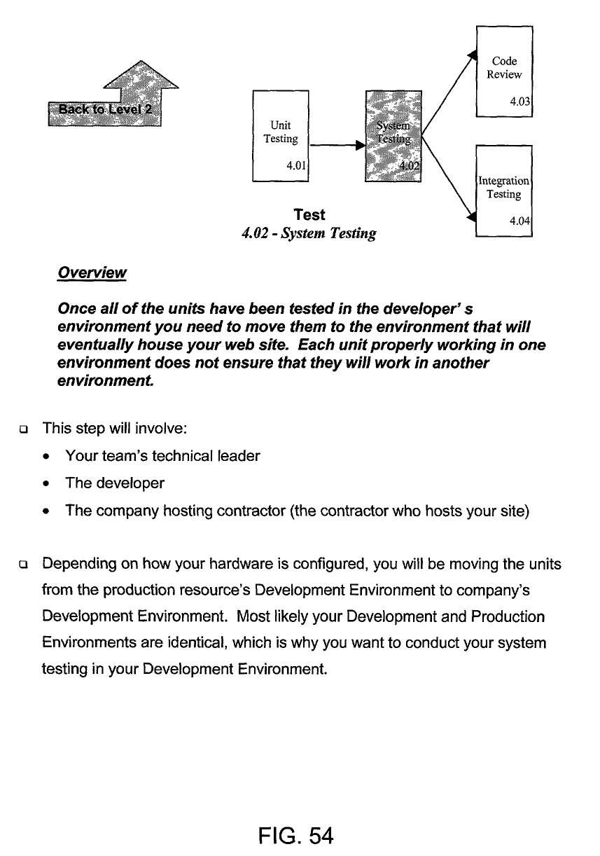

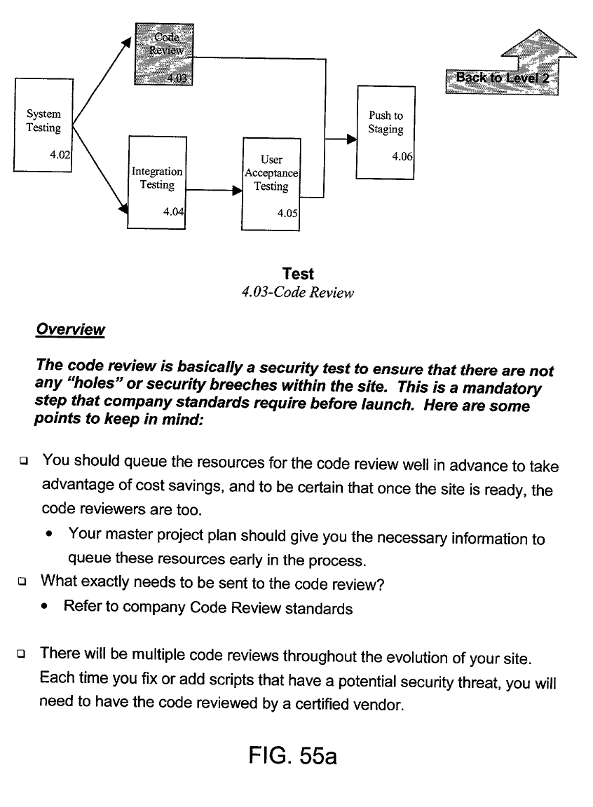

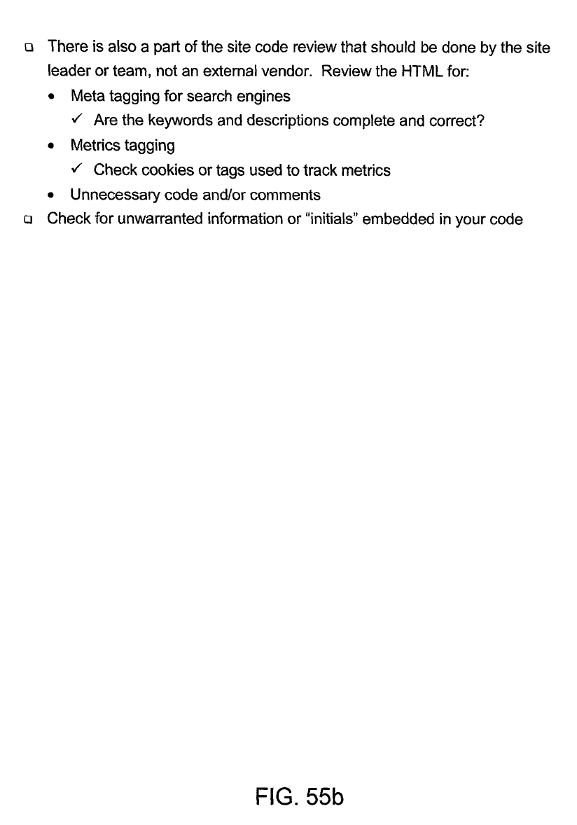

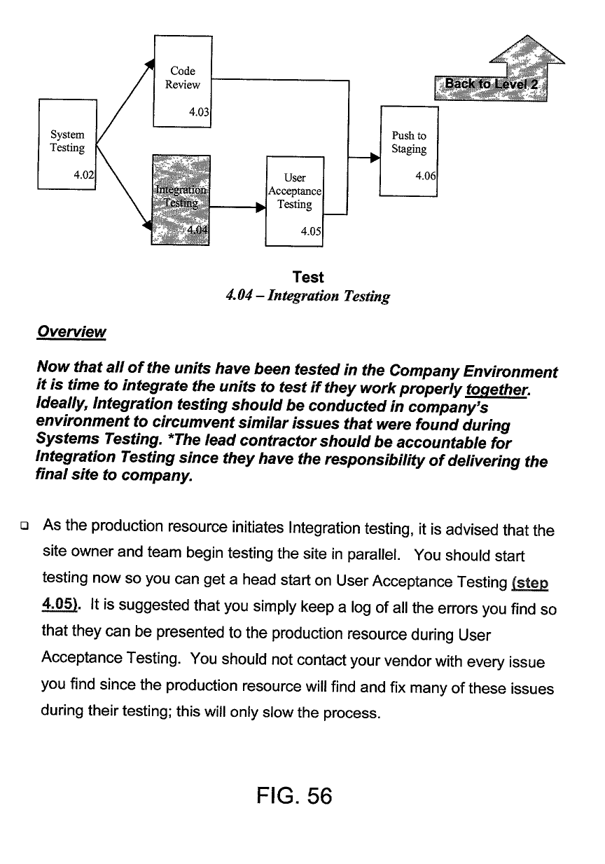

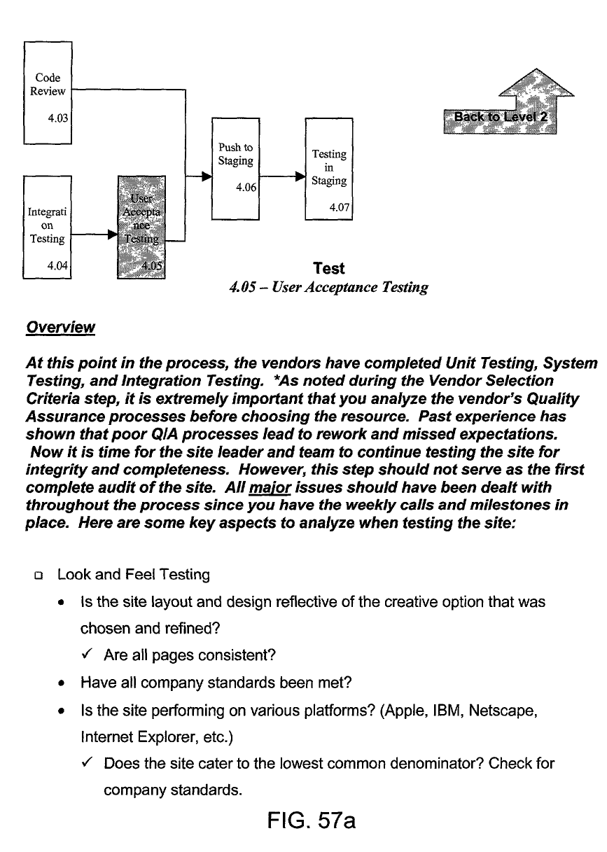

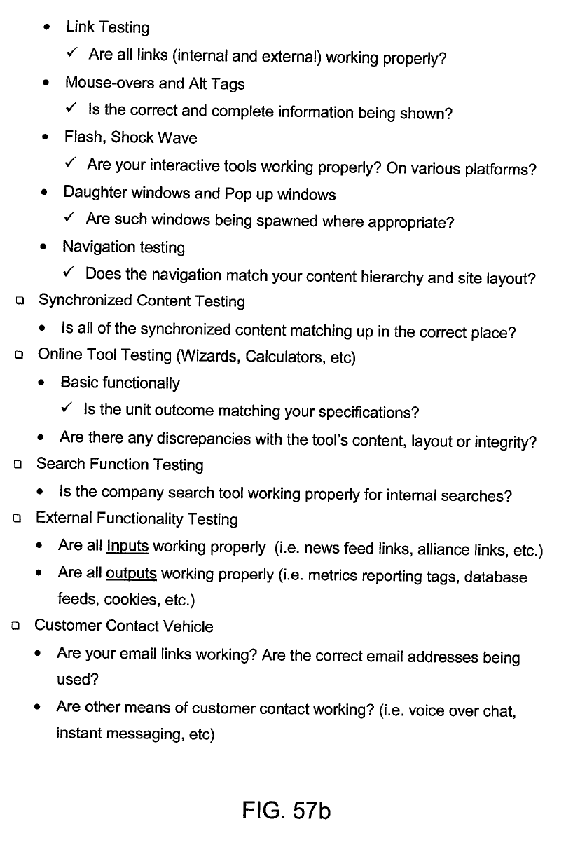

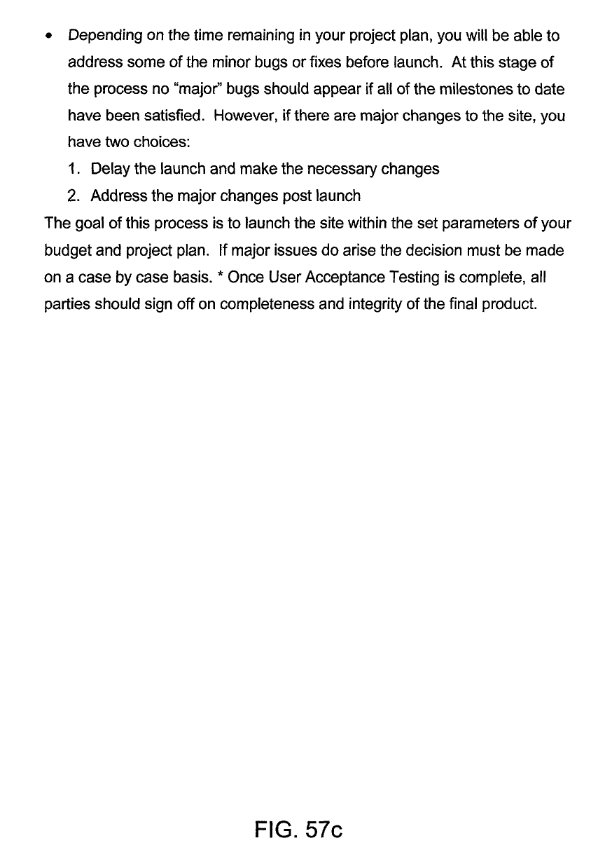

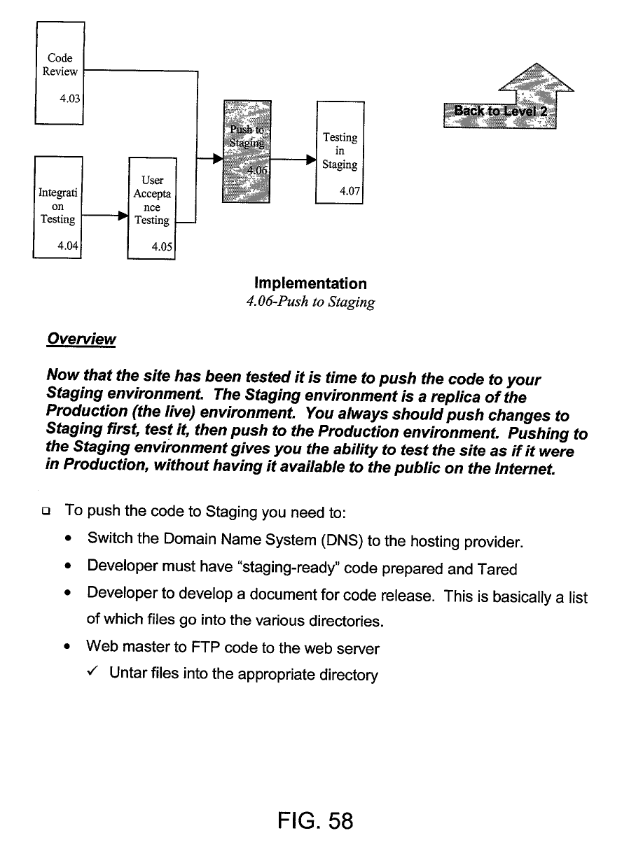

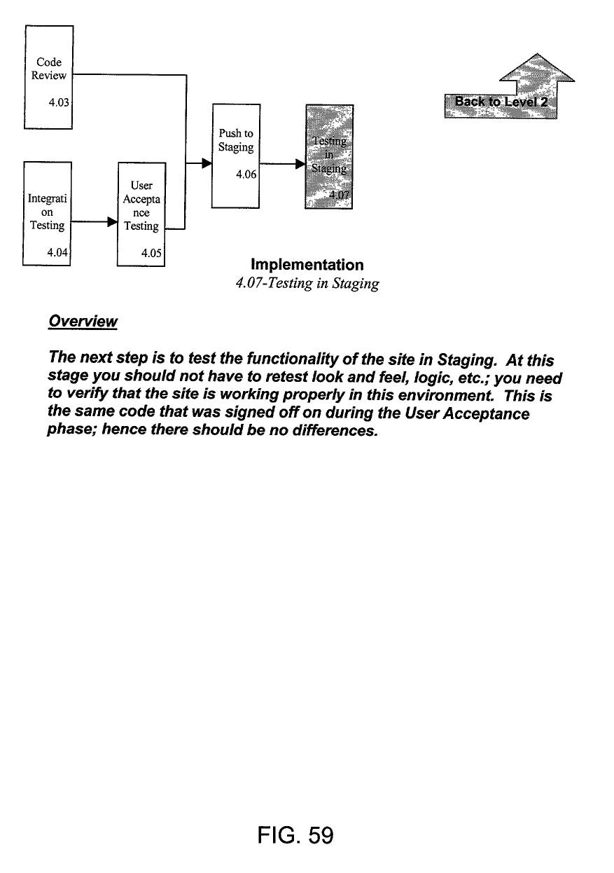

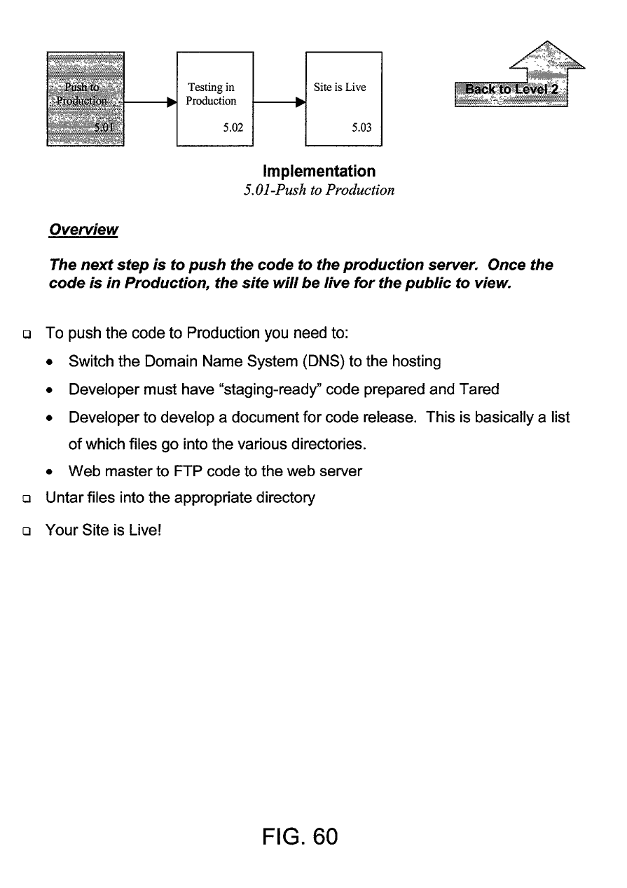

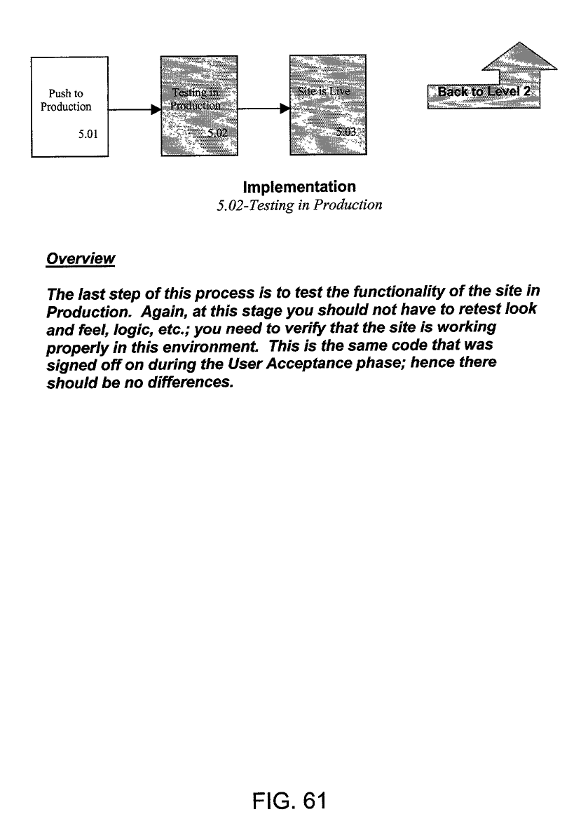

In some embodiments, any displayed representation of a step or a substep may be selected to cause display of a user interface that provides further details of the step or substep. For example, FIGS. 11 through 13 illustrate interfaces that are similar to those shown in FIGS. 2 and 9 but are associated with different ones of process steps 10. That is, each of FIGS. 11 through 13 illustrate representations of substeps for performing one of steps 3.0, 4.0 and 5.0 of process steps 10. Moreover, for the sake of completeness, FIGS. 14 through 61 show user interfaces including a representation of a substep illustrated in one of FIGS. 2, 9 and 11 through 13, representations of at least one and less than all of the substeps preceding the substep, representations of at least one and less than all of the substeps following the substep, and instructions for performing the substep. It will be noted that some user interfaces are illustrated in FIGS. 14 through 61 using more than one drawing sheet. Each drawing sheet of these interfaces is denoted using related indicia, such as FIG. 57a, FIG. 57b and FIG. 57c.

Process steps 800 may be altered to create embodiments of the invention different from or according to any of the arrangements mentioned herein. Moreover, although the present invention has been described with respect to particular embodiments and alternative arrangements thereof, those skilled in the art will note that various substitutions may be made to those embodiments and arrangements without departing from the spirit and scope of the present invention.

What is claimed is:

1. A user interface for managing a project, comprising:
a first area comprising representations of each of a plurality of steps;
a second area comprising representations of a plurality of substeps corresponding to one of the plurality of steps; and
a third area, displayed in response to a selection of one of the plurality of substeps, comprising:
a representation of the selected substep;
representations of at least one and less than all of substeps preceding the selected substep;
representations of at least one and less than all of the substeps following the selected substep; and
instructions for performing the selected substep.

2. A user interface according to claim 1, wherein the representation of the one of the plurality of steps indicates that the plurality of substeps corresponds to the one of the plurality of steps.

3. A user interface according to claim 1, wherein the representation of the selected substep in the third area indicates that the instructions correspond to the selected substep.

4. A user interface according to claim 1, wherein the representations of each of the at least one and less than all of substeps preceding the selected substep and the representations of each of the at least one and less than all of the substeps following the selected substep indicate that the instructions do not correspond to the at least one and less than all of substeps preceding the selected substep or to the at least one and less than all of the substeps following the selected substep.

5. A user interface according to claim 1., wherein the first area and the second area are not displayed simultaneously.

6. A user interface according to claim 5, wherein the third area is displayed simultaneously with the first area.

7. A user interface according to claim 5, wherein the third area is not displayed simultaneously with the first area or with the second area.

8. A user interface according to claim 1, wherein the first area and the second area are displayed simultaneously.

9. A user interface according to claim 8, wherein the third area is not displayed simultaneously with the first area and the second area.

10. A user interface according to claim 1, wherein the third area further comprises a selectable graphic, and wherein a selection of the graphic results in display of the second area.

11. A user interface according to claim 1, further comprising:
representations of each of a plurality of elements of a project framework,
wherein each of the representations of the plurality of steps is displayed in association with one or more of the plurality of elements.

12. A user interface according to claim 1, further comprising:
representations of each of a plurality of elements of a project framework,
wherein each of the representations of the plurality of substeps is displayed in association with one or more of the plurality of elements.

13. A computer-readable medium storing processor-executable process steps to provide a user interface for managing a project, the process steps comprising:
a step to display a first area comprising representations of each of a plurality of steps;
a step to display a second area comprising representations of a plurality of substeps corresponding to one of the plurality of steps;
a step to receive a selection of one of the plurality of substeps; and
a step to display a third area in response to the selection, wherein the third area comprises:
a representation of the selected one of the plurality of substeps;
representations of at least one and less than all of substeps preceding the selected substep;
representations of at least one and less than all of the substeps following the selected substep; and
instructions for performing the selected substep.

14. A medium according to claim 13, wherein the representations of each of the at least one and less than all of substeps preceding the selected substep and the representations of each of the at least one and less than all of the substeps following the selected substep indicate that the instructions do not correspond to the at least one and less than all of substeps preceding the selected substep or to the at least one and less than all of the substeps following the selected substep.

15. A method for providing project management, comprising:
displaying a first area comprising representations of each of a plurality of steps;
displaying a second area comprising representations of a plurality of substeps corresponding to one of the plurality of steps;
receiving a selection of one of the plurality of substeps; and
displaying a third area in response to the selection, wherein the third area comprises:
a representation of the selected one of the plurality of substeps;
representations of at least one and less than all of substeps preceding the selected substep;
representations of at least one and less than all of the substeps following the selected substep; and
instructions for performing the selected substep.

16. A method according to claim 15, wherein the representations of each of the at least one and less than all of substeps preceding the selected substep and the representations of each of the at least one and less than all of the substeps following the selected substep indicate that the instructions do not correspond to the at least one and less than all of substeps preceding the selected substep or to the at least one and less than all of the substeps following the selected substep.

17. An apparatus for managing a project, comprising:
a processor;
a display; and
a storage device in communication with the processor and storing instructions adapted to be executed by the processor to:
display a first area comprising representations of each of a plurality of steps;
display a second area comprising representations of a plurality of substeps corresponding to one of the plurality of steps;
receive a selection of one of the plurality of substeps; and
display a third area in response to the selection, wherein the third area comprises:
a representation of the selected one of the plurality of substeps;
representations of at least one and less than all of substeps preceding the selected substep;
representations of at least one and less than all of the substeps following the selected substep; and
instructions for performing the selected substep.

18. An apparatus according to claim 17, wherein the representations of each of the at least one and less than all of substeps preceding the selected substep and the representations of each of the at least one and less than all of the substeps following the selected substep indicate that the instructions do not correspond to the at least one and less than all of substeps preceding the selected substep or to the at least one and less than all of the substeps following the selected substep.

19. A medium storing processor-executable code to provide a user interface, the user interface comprising:
representations of each of a first plurality of steps; and
representations of each of a plurality of substeps corresponding to one of the first plurality of steps,
wherein one of the representations of the plurality of substeps is selectable to cause display of at least: a representation of the selected substep; representations of at least one and less than all of substeps preceding the selected substep; representations of at least one and less than all of the substeps following the selected substep; and instructions for performing the selected substep.

20. A medium according to claim 19, wherein the representation of the one of the plurality of steps indicates that the plurality of substeps corresponds to the one of the plurality of steps.

21. A medium according to claim 19, wherein the representation of the selected substep in the third area indicates that the instructions correspond to the selected substep.

22. A medium according to claim 19, wherein the representations of each of the at least one and less than all of substeps preceding the selected substep and the representations of each of the at least one and less than all of the substeps following the selected substep indicate that the instructions do not correspond to the at least one and less than all of substeps preceding the selected substep or to the at least one and less than all of the substeps following the selected substep.

23. A medium according to claim 19, wherein the first area and the second area are not displayed simultaneously.

24. A medium according to claim 23, wherein the third area is displayed simultaneously with the first area.

25. A medium according to claim 23, wherein the third area is not displayed simultaneously with the first area or with the second area.

26. A medium according to claim 19, wherein the first area and the second area are displayed simultaneously.

27. A medium according to claim 26, wherein the third area is not displayed simultaneously with the first area and the second area.

28. A medium according to claim 19, wherein the third area further comprises a selectable graphic, and wherein a selection of the graphic results in display of the second area.

29. A medium according to claim 19, further comprising:
representations of each of a plurality of elements of a project framework,
wherein each of the representations of the plurality of steps is displayed in association with one or more of the plurality of elements.

30. A medium according to claim 19, further comprising:
representations of each of a plurality of elements of a project framework,
wherein each of the representations of the plurality of substeps is displayed in association with one or more of the plurality of elements.
